(19) United States
(12) Patent Application Publication
(10) Pub. No.: US 2005/0034370 A1
(43) Pub. Date: Feb. 17, 2005

(54) Liquid impermeable decorative sleeve for flower pot

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/934,069

(22) Filed: Sep. 3, 2004

Related U.S. Application Data
(63) Continuation of application No. 10/611,128, filed on Jul. 1, 2003, now abandoned.
Application No. 10/611,128 is a continuation of application No. 09/847,730, filed on May 2, 2001, now abandoned.
(63) Continuation-in-part of application No. 10/629,283, filed on Jul. 29, 2003.
Application No. 10/629,283 is a continuation of application No. 10/299,767, filed on Nov. 18, 2002, now Pat. No. 6,618,991.
Application No. 10/299,767 is a continuation of application No. 10/150,806, filed on May 6, 2002, now Pat. No. 6,502,351.
Application No. 10/150,806 is a continuation of application No. 10/014,779, filed on Oct. 26, 2001, now Pat. No. 6,484,443.
Application No. 10/014,779 is a continuation of application No. 09/687,025, filed on Oct. 13, 2000, now Pat. No. 6,347,481.
Application No. 09/687,025 is a continuation of application No. 09/366,440, filed on Aug. 3, 1999, now Pat. No. 6,141,906.
Application No. 09/366,440 is a continuation of application No. 08/851,058, filed on May 5, 1997, now Pat. No. 5,941,020.
Application No. 08/851,058 is a continuation of application No. 08/237,078, filed on May 3, 1994, now Pat. No. 5,625,979.
Application No. 08/237,078 is a continuation-in-part of application No. 08/220,852, filed on Mar. 31, 1994, now Pat. No. 5,572,851.
(60) Provisional application No. 60/201,192, filed on May 2, 2000.

(51) Int. Cl. A01G 9/02

(52) U.S. Cl. 47/72

(57) ABSTRACT

A substantially liquid impermeable package for wrapping about a floral grouping or potted plant is disclosed, as well as methods for producing and using same. The substantially liquid impermeable package is formed of a flexible sleeve constructed from a material which is substantially liquid impermeable and which includes at least one layer of polymeric film. The flexible sleeve is provided with seals in a sidewall and closed lower end thereof which are substantially liquid impermeable.

### CROSS REFERENCE TO RELATED APPLICATIONS

This application is a continuation of U.S. Ser. No. 10/611,128, filed Jul. 1, 2003; which is a continuation of U.S. Ser. No. 09/847,730, filed May 2, 2001, now abandoned; which claims the benefit under 35 U.S.C. 119(e) of provisional Application No. 60/201,192, entitled “LIQUID IMPERMEABLE DECORATIVE SLEEVE FOR FLOWER POT OR FLORAL GROUPING”, filed May 2, 2000, the contents of each of which are hereby expressly incorporated herein by reference.

This application is also a continuation-in-part of U.S. Ser. No. 10/629,283, filed Jul. 29, 2003; which is a continuation of U.S. Ser. No. 10/299,767, filed Nov. 18, 2002, now U.S. Pat. No. 6,618,991, issued Sep. 16, 2003; which is a continuation of U.S. Ser. No. 10/150,806, filed May 6, 2002, now U.S. Pat. No. 6,502,351, issued Jan. 7, 2003; which is a continuation of U.S. Ser. No. 10/014,779, filed Oct. 26, 2001, now U.S. Pat. No. 6,484,443, issued Nov. 26, 2002; which is a continuation of U.S. Ser. No. 09/687,025, filed Oct. 13, 2000, now U.S. Pat. No. 6,347,481, issued Feb. 19, 2002; which is a continuation of U.S. Ser. No. 09/366,440, filed August 3, 1999, now U.S. Pat. No. 6,141,906, issued Nov. 7, 2000; which is a continuation of 08/851,058, filed May 5, 1997, now U.S. Pat. No. 5,941,020, issued Aug. 24, 1999; which is a continuation of U.S. Ser. No. 08/237,078, filed May 3, 1994, now U.S. Pat. No. 5,625,979, issued May 6, 1997; which is a continuation-in-part of U.S. Ser. No. 08/220,852, filed Mar. 31, 1994, now U.S. Pat. No. 5,572,851, issued Nov. 12, 1996, the contents of each of which are hereby expressly incorporated herein by reference.

### STATEMENT REGARDING FEDERALLY SPONSORED RESEARCH OR DEVELOPMENT

Not Applicable.

### BACKGROUND OF THE INVENTION

1. Field of the Invention

The present invention generally relates to sleeves to be used as containers, and more particularly, but not by way of limitation, to liquid impermeable sleeves used as decorative containers or coverings for floral groupings, flower pots and/or media containing floral groupings, and methods of using same.

2. Brief Description of the Art

It is well known in the floral packaging industry to apply floral sleeves or bags about potted plants for the purpose of erecting a protective sheath about the blooms and foliage of the potted plant for preventing damage to them and entanglement with adjacent plants.

Certain of the prior art sleeves have closed lower ends upon which the bottom of the pot can rest. Such sleeves are often liquid permeable because of the methods heretofore employed to seal the lower end of the sleeve.

While the sleeves of the prior art provide a decorative appearance to the potted plant or floral grouping disposed therein, maintenance of such potted plant or floral grouping precludes long term storage in the sleeve. The potted plant or floral grouping requires water and/or other liquid growing medium for maintaining a pleasing and decorative appearance, and the sleeves of the prior art are not leak proof and therefore leak liquids through the seals formed therein. Liquid leakage through the seals of the sleeve can result in distortion of various colorings, printings and/or embossings provided on the sleeve which contribute to the decorative appearance of the sleeve. Further, the material from which the sleeve is constructed may deteriorate upon exposure to the liquid. In addition, the surface upon which the sleeve containing the potted plant or floral grouping is displayed may be damaged by exposure to liquids leaking from the sleeve. Therefore, a need exists for a leak proof decorative sleeve.

An object of the present invention is therefore to provide a liquid impermeable sleeve which will prevent leakage of liquids disposed therein.

Other objects, features and advantages of the present invention will become apparent from the following detailed description when read in conjunction with the accompanying drawings.

### BRIEF DESCRIPTION OF THE DRAWINGS

FIG. 1 is a perspective view of a liquid impermeable gusseted sleeve constructed in accordance with the present invention, the liquid impermeable gusseted sleeve being illustrated in a substantially flattened condition.

FIG. 2 is a cross-sectional view of the sleeve of FIG. 1 taken along line 2-2.

FIG. 3 is a perspective view of the sleeve of FIG. 1 in an opened condition and having a flower pot disposed therein.

FIG. 4A is a cross-sectional view similar to FIG. 2 of another embodiment of a liquid impermeable sleeve constructed in accordance with the present invention, wherein the sleeve is in a substantially flattened condition and the sidewall of the sleeve is provided with lap seals.

FIG. 4B is a cross-sectional view of another embodiment of a liquid impermeable sleeve similar to the liquid impermeable sleeve of FIG. 4A, except that the lap seals are configured in a different manner than the lap seals of the liquid impermeable sleeve of FIG. 4A.

FIG. 5 is a cross-sectional view similar to FIG. 2 of another embodiment of a liquid impermeable sleeve constructed in accordance with the present invention, wherein the sleeve is in a substantially flattened condition and the sidewall of the sleeve is provided with fin seals.

FIG. 6 is a cross-sectional view similar to FIG. 2 of another embodiment of a liquid impermeable sleeve constructed in accordance with the present invention, wherein the sleeve is in a substantially flattened condition and the sidewall of the sleeve is provided with butt seals.

FIG. 7 is a cross-sectional view similar to FIG. 2 of another embodiment of a liquid impermeable sleeve constructed in accordance with the present invention, wherein the sleeve is in a substantially flattened condition and the sidewall of the sleeve is provided with zippers therein for connecting the sidewall of the sleeve.

FIG. 8 is a perspective view of a liquid impermeable sleeve constructed in accordance with the present invention, the liquid impermeable sleeve being illustrated in a substantially flattened condition.

FIG. 9 is a perspective view of the sleeve of FIG. 8 in an opened condition and having a flower pot disposed therein.

FIG. 10 is a perspective view of the sleeve of FIG. 9 having the flower pot disposed therein wherein an upper portion of the sleeve has been removed.

FIG. 11 is a cross-sectional view of another embodiment of a liquid impermeable sleeve constructed in accordance with the present invention.

FIG. 12 is an elevational view of another embodiment of a liquid impermeable sleeve constructed in accordance with the present invention.

FIG. 13 is a perspective view of the sleeve of FIG. 12 in an opened condition and having a flower pot disposed therein.

FIG. 14 is a perspective view of the sleeve of FIG. 13 having the flower pot disposed therein wherein an upper portion of the sleeve has been removed.

FIG. 15 is a perspective view of a liquid impermeable sleeve for a floral grouping constructed in accordance with the present invention.

FIG. 16 is a perspective view of the sleeve of FIG. 15 having a floral grouping disposed therein.

FIG. 17 is a perspective view of the sleeve of FIG. 15 having a floral grouping disposed therein wherein a portion of the sleeve is crimped about a stem portion of the floral grouping.

FIG. 18 is a perspective view of another embodiment of a liquid impermeable sleeve for a floral grouping constructed in accordance with the present invention.

FIG. 19 is a perspective view of the liquid impermeable sleeve of FIG. 18 having a floral grouping disposed therein and wherein an upper portion of the sleeve has been removed.

FIG. 20 is a perspective view of another embodiment of a liquid impermeable sleeve constructed in accordance with the present invention.

FIG. 21 is a perspective view of a liquid impermeable plant package constructed in accordance with the present invention, wherein a first sleeve is disposed within a second sleeve.

FIG. 22 is a perspective view of a liquid impermeable sleeve constructed in accordance with the present invention, wherein the liquid impermeable sleeve is provided with two gussets in each side of the liquid impermeable sleeve.

FIG. 23 is a perspective view of a liquid impermeable sleeve constructed in accordance with the present invention, wherein the liquid impermeable sleeve is provided with a gusset in each side thereof and a gusset in a lower end thereof.

FIG. 24 is a perspective view of a liquid impermeable sleeve similar to the liquid impermeable sleeve of FIG. 23 except that a gusseted bottom of the sleeve is provided with a concave lower end.

FIG. 25 is a perspective view of a liquid impermeable sleeve constructed in accordance with the present invention, the liquid impermeable sleeve provided with expansion elements for enhancing extension of a skirt portion thereof once an upper portion of the liquid impermeable sleeve is removed.

FIG. 26 is a perspective view of the liquid impermeable sleeve of FIG. 25 having a flower pot disposed therein, wherein the upper portion of the liquid impermeable sleeve has been removed and the skirt portion is extended.

FIG. 27 is a perspective view of a liquid impermeable sleeve similar to the liquid impermeable sleeve of FIG. 25 except the expansion elements do not extend completely to an upper end of the liquid impermeable sleeve.

FIG. 28 is a cross sectional view of the liquid impermeable sleeve of FIG. 27 taken along line 28-28.

FIG. 29 is a perspective view of a liquid impermeable sleeve similar to the liquid impermeable sleeve of FIG. 27, except that the liquid impermeable sleeve is provided with a support extension on an upper end thereof.

FIG. 30 is a perspective view of a liquid impermeable sleeve similar to the liquid impermeable sleeve of FIG. 29, except that the liquid impermeable sleeve is provided with handles on an upper end thereof.

### DETAILED DESCRIPTION OF THE INVENTION

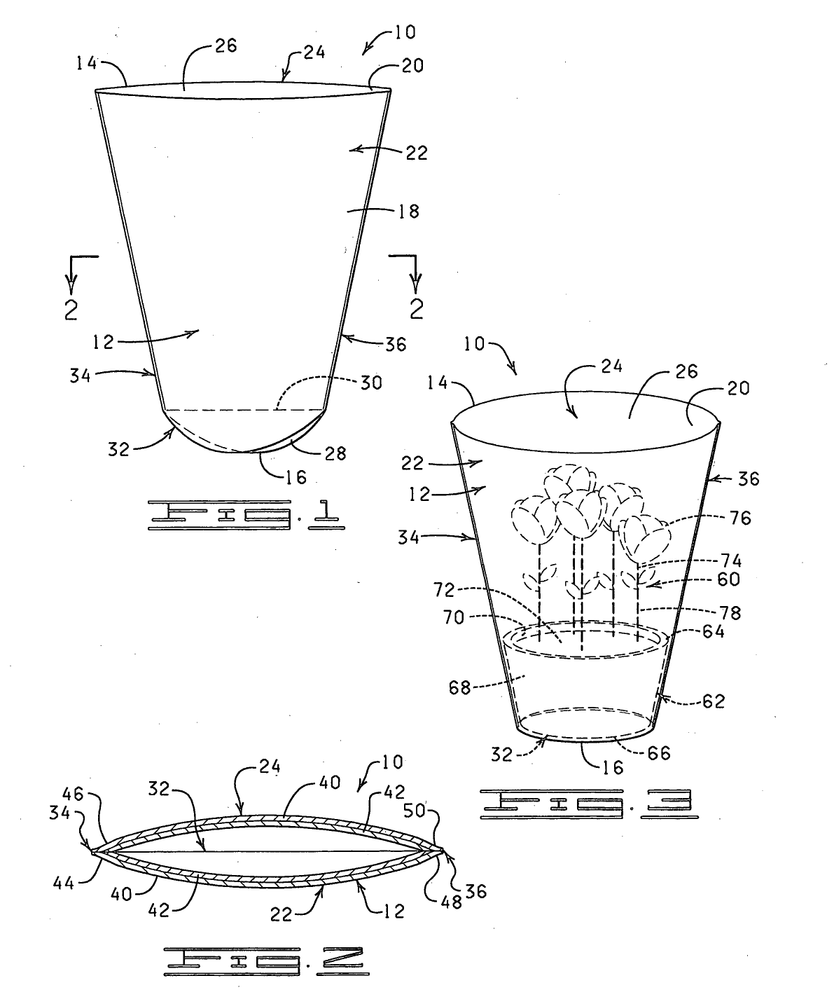

Description of FIGS. 1-3

Shown in FIGS. 1-3 and designated therein by the reference numeral 10 is a liquid impermeable flexible bag or sleeve. The liquid impermeable sleeve 10, which is formed of a sheet of liquid impermeable material, is provided with a sidewall 12, an open upper end 14 and a closed lower end 16. The sidewall 12 is characterized as having an outer surface 18 and an inner surface 20 and comprises a first side 22 and a second side 24. The liquid impermeable sleeve 10 is shown in a substantially flattened state in FIG. 1 and is openable to an open state, as shown in FIG. 3. In the open state, an inner retaining space 26 is provided in the liquid impermeable sleeve 10 wherein a floral grouping or flower pot may be disposed. The inner retaining space 26 is surrounded by the inner surface 20 of the sidewall 12 and is accessible through the open upper end 14 of the liquid impermeable sleeve 10. A portion of the closed lower end 16 of the liquid impermeable sleeve 10 may be inwardly folded to form one or more gussets 28 having an inner fold 30, the gusset 28 (only one gusset 28 shown in FIG. 1) permitting a circular bottom of an object such as a flower pot to be disposed in the inner retaining space 26 of the liquid impermeable sleeve 10. However, it will be understood that the gusset 28 may also accommodate objects having bottoms of various shapes, and the inner retaining space 26 of the liquid impermeable sleeve 10 having a gusset 28 is not limited to holding objects with circular bottoms. In addition, the gusset 28 may be provided such that upon unfolding thereof, a void space is provided under and/or around the bottom of an object. Such void space produced by the gusset 28 provides a water reservoir in which water can collect and will not be leaked from the liquid impermeable sleeve 10. Further embodiments of sleeves provided with gussets will be described in more detail herein below.

In an opened state, the liquid impermeable sleeve 10 may be tapered and may assume various shapes and configurations, such as cylindrical, frusto-conical, coniform, and combinations thereof, as long as the liquid impermeable sleeve 10 functions in accordance with the present invention in the manner described herein. Further, the liquid impermeable sleeve 10 may have any shape, whether geometric, non-geometric, asymmetrical and/or fanciful, as long as it functions in accordance with the present invention.

Any thickness of the sheet of liquid impermeable material from which the liquid impermeable sleeve 10 is formed may be utilized as long as the liquid impermeable sleeve 10 may be formed as described herein, as long as the formed liquid impermeable sleeve 10 may contain at least a portion of a flower pot or potted plant or a floral grouping as described herein, and as long as the formed liquid impermeable sleeve 10 functions in accordance with the present invention as described herein. Generally, however, the sheet of material employed in the formation of the liquid impermeable sleeve 10 will have a thickness in a range of from about 0.1 mil to about 30 mil.

In the formation of the liquid impermeable sleeve 10, portions of the sheet of liquid impermeable material from which the liquid impermeable sleeve 10 is constructed are brought into contact to form overlapping or adjacent portions which are bondingly connected together to form seals, wherein the seals are liquid impermeable. When the liquid impermeable sleeve 10 is constructed of a single sheet of liquid impermeable material, the closed lower end 16 of the liquid impermeable sleeve 10 is not provided with a seal therein and therefore does not have to be sealed. When the liquid impermeable sleeve 10 is formed from two or more sheets of material, adjacent or overlapping portions of the liquid impermeable sleeve 10 may be brought together and sealed to form one or more seals 32 in the closed lower end 16 thereof which are liquid impermeable. Portions of the first and second sides 22 and 24 of the sidewall 12 may be brought together to form adjacent or overlapping portions which are sealed to form liquid impermeable seals 34 and 36 which connect the first and second sides 22 and 24 of the sidewall 12 and delineate the outer surface 18 of the sidewall 12 from the inner surface 20 of the sidewall 12 of the liquid impermeable sleeve 10.

The sleeve 10 formed as described herein must be liquid impermeable. The term “liquid impermeable” as used herein means that liquid contained within the liquid impermeable sleeve 10 will be retained in the liquid impermeable sleeve 10 and will not leak through either the sheet of liquid impermeable material from which the liquid impermeable sleeve 10 is constructed or through the seal 32 of the closed lower end 16 or through the liquid impermeable seals 34 and 36 of the sidewall 12 of the liquid impermeable sleeve 10. The term “liquid impermeable” may be used interchangeably with the terms “leak proof”, “leak resistant”, “fluid impermeable” and “watertight”.

The sheet of liquid impermeable material from which the liquid impermeable sleeve 10 is constructed must be liquid impermeable and must be capable of being formed into a liquid impermeable sleeve 10 which can be disposed about a flower pot or floral grouping. The sheet of liquid impermeable material from which the liquid impermeable sleeve 10 is formed is desirably constructed of two or more layers of materials, such as two sheets of polymeric film, wherein one of the layers of material has a lower melting temperature than the other layer of material such that upon forming an overlapping portion of the sheet of liquid impermeable material into the seal 32 of the closed lower end 16 and an overlapping portion of the sheet of material into the seals 34 and 36 of the sidewall 12 of the liquid impermeable sleeve 10, the layer of material having a lower melting temperature will flow into any voids or micropores formed in the other layer of material of the seals 32, 34 and 36 upon sealing to render the seals 32, 34 and 36 liquid impermeable (i.e., leak proof seals).

The term “polymeric film” as used herein will be understood to include synthetic polymers such as polypropylene or polyethylene as well as naturally occurring polymers such as cellophane. A polymeric film is relatively strong and not as subject to tearing (substantially non-tearable), as might be the case with paper or foil. Preferred examples of such polymeric films include high density polyethylene (HDPE), low density polyethylene (LDPE), linear low density polyethylene (LLDPE), oriented polypropylene (OPP), biaxially oriented polypropylene (BOPP), cast polypropylene (CPP), ethyl vinyl acetate (EVA), polyvinyl choride (PVC), polyvinylidene chloride (PVDC), ethylene vinyl alcohol (EVOH), polystyrene (PS), or polyethylene terephthlate (PET).

Preferably, the liquid impermeable sleeve 10 is constructed of a laminate of two or more layers of polymeric film, such as a laminate formed of BOPP laminated to HDPE, LDPE or LLDPE. Such materials provide a necessary stiffness without excessive thickness and will still provide adequate sealing for waterproof and strength requirements. Examples of preferred laminated materials which can be utilized in accordance with the present invention include HDPE laminated to clear, coextruded BOPP, HDPE laminated to white, expanded, coextruded BOPP, HDPE laminated to metallized, expanded, coextruded BOPP, HDPE laminated to metallized, coextruded BOPP, HDPE laminated to a clear, white or metallized homopolymer, and CPP laminated to any of the above materials to which laminates to HDPE are described.

When the sheet of liquid impermeable material from which the liquid impermeable sleeve 10 is constructed is a laminate of two or more layers of material, one of the layers of material may be liquid impermeable, or neither of the layers of material may be liquid impermeable when used alone, while the laminate formed therefrom is liquid impermeable. Alternatively, both layers of material of the sheet of liquid impermeable material may be liquid impermeable, but when a seal is formed from overlapping portions of one of the layers of material alone, voids or micropores are formed therein which render the seal permeable to liquids. When one of the layers of material of the sheet of liquid impermeable material from which the liquid impermeable sleeve 10 is constructed is liquid impermeable or when one of the layers of material forms more liquid impermeable seals, the more liquid impermeable layer of material is desirably located adjacent the inner surface 20 of the sidewall 12 and therefore on the inside of the liquid impermeable sleeve 10. For example, the sheet of material may be a laminate of BOPP and HDPE, and HDPE may be located adjacent the inner surface 20 of the sidewall 12 of the liquid impermeable sleeve 10. However, it will be understood that the more liquid impermeable layer of material of the sheet of liquid impermeable material may also be located adjacent the outer surface 18 of the sidewall 12 and therefore the outside of the liquid impermeable sleeve 10.

Alternatively, the liquid impermeable sleeve 10 may be constructed of a sheet of liquid impermeable material which comprises a sheet of material having an extrusion coating thereon, such as an extrusion coating of a polymeric film with a second polymer. In this instance, the extrusion coating will have a lower melting temperature than the sheet of material of the sheet of liquid impermeable material, and thus will flow into any voids or micropores formed in the adjacent or overlapping portions of the sheet of material which form the seal 32 of the closed lower end 16 and the seals 34 and 36 of the sidewall 12 of the liquid impermeable sleeve 10, thereby forming a liquid impermeable sleeve 10 having liquid impermeable seals 32, 34 and 36. By using a more expensive, stronger material for the extrusion coating and only coating the portion of the sheet of material of the sheet of liquid impermeable material substantially adjacent the area which will form the seals 32, 34 and 36 of the liquid impermeable sleeve 10, a less expensive, weaker polymeric film may be used as the sheet of material and will result in a liquid impermeable sleeve 10 possessing the superior seal strength and thus liquid impermeability of the extrusion coating without the expense of extrusion coating the entire surface of the sheet of material. An example of such a sheet of material is BOPP coextruded with LDPE, LLDPE or HDPE.

In yet another alternative, the liquid impermeable sleeve 10 may be constructed of a sheet of liquid impermeable material comprising a sheet of material having a bonding material disposed upon the portion of the sheet of material substantially adjacent the area which will form the seal 32 of the closed lower end 16 and seals 34 and 36 of the sidewall 12 of the liquid impermeable sleeve 10. The term “bonding material” as used herein includes adhesives, preferably pressure sensitive adhesives, cohesives, heat sealable materials, sonic sealable materials, vibratory sealable materials, and cold seal materials.

For the sake of brevity, the sleeves described herein and depicted in the figures are formed of a sheet of liquid impermeable material comprising a laminate of two layers of material, i.e., a laminate of BOPP and HDPE. However, it will be understood that the sleeves of the present invention are not limited to construction from a sheet of liquid impermeable material comprising a laminate of two layers but may also be constructed of a sheet of liquid impermeable material comprising a laminate of three or more layers, an extrusion coated material or a material having a bonding material disposed upon a portion thereof.

In addition, the present invention also includes the use of tape having a bonding material disposed thereon to form the seals 32, 34 and/or 36 of the liquid impermeable sleeve 10. The tape may be applied over the overlapping portions of the closed lower end 16 to form the seal 32 and over overlapping portions of the sidewall 12 to form the seals 34 and 36, or folds may be formed in the lower end 36 and/or sidewall 12 prior to overlapping and applying tape thereto to form the seals 32 and/or 34 and 36, respectively. That is, the seal 32 in the closed lower end 16 of the liquid impermeable sleeve 10 may be formed by the application of an extrusion coating to the portion of the sheet of liquid impermeable material forming the seal 32, while the portion of the sheet of liquid impermeable material forming the seals 34 and 36 is provided with a bonding material thereon to effect the sealing of the seals 34 and 36. In addition, one of the seals 32, 34 and 36 of the liquid impermeable sleeve 10 may be formed by more than one method of providing a liquid impermeable seal disclosed herein. For example, the portion of the sheet of liquid impermeable material from which the liquid impermeable sleeve 10 is constructed and which forms the seals 34 and 36 may be provided with a bonding material thereon, and following the formation of overlapping portions held together by the bonding material, tape may be applied thereto to ensure the liquid impermeability of the seals 34 and 36 of the liquid impermeable sleeve 10.

Either or both of the two layers of the sheet of liquid impermeable material from which the liquid impermeable sleeve 10 is constructed may vary in color and may consist of designs or decorative patterns which are printed, etched and/or embossed thereon using inks or other printing or embossing materials. An example of an ink which may be applied to the surface of the material is described in U.S. Pat. No. 5,147,706 entitled “Water Based Ink On Foil And/Or Synthetic Organic Polymer” issued to Kingman on Sep. 15, 1992 and which is hereby expressly incorporated herein by reference. When provided in combination, the printed and embossed patterns may be in or out of register with one another.

In addition, either or both of the two layers of material of the sheet of liquid impermeable material from which the liquid impermeable sleeve 10 is constructed may have various colorings, coatings, flocking and/or metallic finishes or other decorative surface ornamentation applied separately or simultaneously or may be characterized totally or partially by pearlescent, translucent, transparent, opaque, iridescent, neon, or the like qualities. Each of the above-named characteristics may occur alone or in combination and may be applied to the upper and/or lower surface of either or both of the layers of material of the sheet of material liquid impermeable from which the liquid impermeable sleeve 10 is formed. Moreover, portions of the sheet of liquid impermeable material used in constructing the liquid impermeable sleeve 10 may vary in the combination of such characteristics.

As stated above, for the sleeve 10 to be liquid impermeable, not only will the sheet of liquid impermeable material from which the liquid impermeable sleeve 10 is constructed need to be liquid impermeable, but the seal 32 of the closed lower end 16 and the seals 34 and 36 of the sidewall 12 of the liquid impermeable sleeve 10 must also be liquid impermeable and must not leak liquid retained in the liquid impermeable sleeve 10. To achieve liquid impermeable seals 32, 34 and 36, several types of seals may be used. One type of seal is illustrated in FIG. 2 and described in greater detail hereinbelow. The seals 32, 34 and 36 will typically be sealed by application of heat and/or pressure, and the seals 32, 34 and 36 of the liquid impermeable sleeve 10 constructed of the sheet of liquid impermeable material comprising a laminate of two layers of material are stronger and therefore more liquid impermeable than seals formed of either layer of material alone. When the sheet of liquid impermeable material comprises a laminate of two layers of material and heat is used to form the seals 32, 34 and 36, typically one layer of material of the sheet of liquid impermeable material melts at a temperature below the melting temperature of the other layer of material, thereby preventing melting and distortion of the other layer of material. In addition, the seals 32, 34 and 36 must be of a sufficient strength to withstand substantial abuse immediately following melting as well as during subsequent filling, shipping and handling and still retain the liquid impermeable characteristics required.

Shown in FIG. 2 is a cross-sectional view of the liquid impermeable sleeve 10 taken along line 2-2 thereof and depicts adjacent portions of the sheet of liquid impermeable material of the sidewall 12 of the liquid impermeable sleeve 10 which are sealed in such a manner to provide the leak proof seals 34 and 36. The sheet of liquid impermeable material from which the liquid impermeable sleeve 10 is constructed is a laminate formed of a first layer of material 40 and a second layer of material 42. The second layer of material 42 has a lower melting temperature than the first layer of material 40, and the overlapping or adjacent portions of the second layer of material 42 of the first and second sides 22 and 24 of the sidewall 12 are melted or fused to form the seal 34 between a first end 44 of the first side 22 of the sidewall and a first end 46 of the second side 24 of the sidewall 12, and the first and second sides 22 and 24 of the sidewall 12 are also melted or fused to form the seal 36 between a second end 48 of the first side 22 of the sidewall 12 and a second end 50 of the second side 24 of the sidewall 12 so as to form strong weld seals 34 and 36. The first layer of material 40 may also be melted so as to contribute to the integrity of the weld seals 34 and 36, but the majority of the strength of the weld seals 34 and 36 will be derived from the second layer of material 42.

Preferably, the first layer of material 40 is BOPP and the second layer of material 42 is LDPE, LLDPE or HDPE. BOPP is the desired first layer of material 40 for several reasons: (1) BOPP has a stiffness which allows the liquid impermeable sleeve 10 formed therefrom to hold its shape well even when used at a minimum level of thickness; (2) BOPP is readily available and inexpensive; (3) BOPP is available in a variety of thicknesses and widths; (4) BOPP is available in a crystal clear transparent film; and (5) BOPP can be readily printed and/or metallized. The second layer of material 42 is desirably HDPE, LDPE, or LLDPE because these materials form more liquid impermeable seals than BOPP alone and do not have the clarity and gloss of BOPP, nor do they have the stiffness of BOPP. Alternatively, BOPP may be the interior layer and LDPE, LLDPE or HDPE the outer layer, that is, the first layer of material 40 may be LDPE, LLDPE, or HDPE and the second layer of material 42 may be BOPP.

It will generally be desired to use the liquid impermeable sleeve 10 as a covering for a potted plant 60, as shown in FIG. 3. The potted plant 60 comprises a flower pot 62 having an upper end 64, a lower end 66, an outer peripheral surface 68 and an inner peripheral surface 70 encompassing an inner retaining space 72 adapted for receiving and retaining a floral grouping or plant 74. The lower end 66 of the flower pot 62 is closed but may have holes for permitting water drainage. Examples of flower pots 62 which may be used in accordance with the present invention include clay pots, wooden pots, plastic pots, pots made from natural or synthetic fibers, or any combination thereof. The floral grouping or plant 74 may be disposed within the flower pot 62 along with a suitable growing medium (not shown) or other retaining medium, such as a floral foam. It will be understood that the floral grouping or plant 74, and any appropriate growing medium or other retaining medium, may be disposed in the liquid impermeable sleeve 10 without the flower pot 62, for example, for the purpose of cultivating the plant within the liquid impermeable sleeve 10.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping or plant 74 may comprise a bloom or foliage portion 76 and a stem portion 78 (FIG. 3). The floral grouping or plant 74 may also include a root portion as well (not shown). However, it will be appreciated that the floral grouping 74 may consist of only a single bloom or only foliage, or a botanical item, or a propagule. The term “floral grouping” may be used interchangeably herein with the terms “floral arrangement”, “plant”, “botanical item” and/or “propagule”.

The term “growing medium” as used herein means any liquid, solid or gaseous material used for plant growth and/or maintenance or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” as used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as a bouquet or floral grouping.

The term “propagule” when used herein means any structure capable of being propagated or acting as an agent of reproduction including seeds, shoots, stems, runners, tubers, plants, leaves, roots or spores.

In a method of use of the liquid impermeable sleeve 10, the liquid impermeable sleeve 10 is opened to an open position (FIG. 3), and the potted plant 60 is placed within the inner retaining space 26 of the liquid impermeable sleeve 10 such that the lower end 66 of the flower pot 62 of the potted plant 60 is disposed substantially adjacent the closed lower end 16 of the liquid impermeable sleeve 10. When the liquid impermeable sleeve 10 contains the gusset 28, a portion of the gusset 28 is positioned against the lower end 66 of the flower pot 62 to form part of the closed lower end 16 of the liquid impermeable sleeve 10. As such, the gusset 28 contributes to the closed lower end 16 to prevent stress thereupon by stretching or distorting the shape of the closed lower end 16 so that the seal 32 (FIGS. 1-3) is not exposed to undue strain which might stretch the seal 32 and reduce the liquid impermeability and liquid retention capabilities of the liquid impermeable sleeve 10. The use of gussets in sleeves is described in detail in copending U.S. application Ser. No. 09/549,646 entitled “Flat Sleeve Convertible to a Decorative Container” filed Apr. 14, 2000, the Specification of which is hereby expressly incorporated herein by reference.

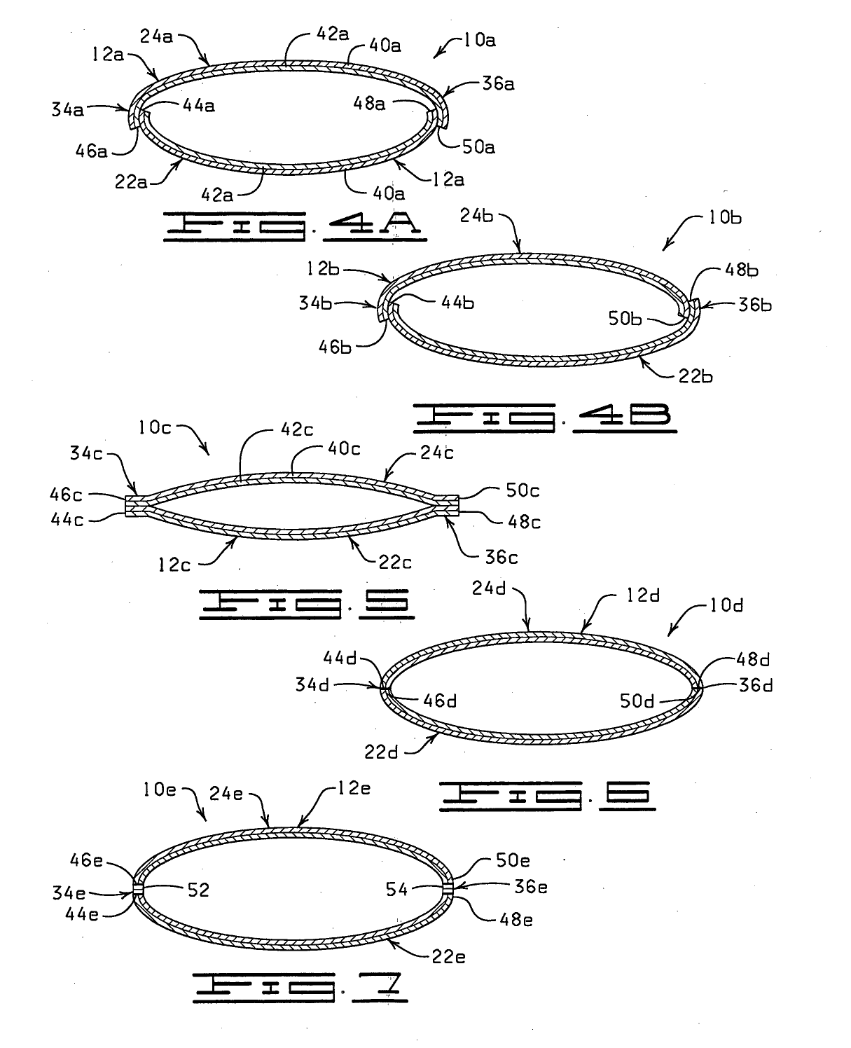

Description of FIGS. 4A-7

Shown in FIG. 4A is a cross-sectional view of another embodiment of a liquid impermeable sleeve designated by the reference numeral 10a. The liquid impermeable sleeve 10a is similar to the liquid impermeable sleeve 10 described hereinabove and illustrated in FIGS. 1-3, except as described hereinbelow. The liquid impermeable sleeve 10a is provided with a sidewall 12a comprising a first side 22a having a first and second ends 44a and 48a and a second side 24a having first and second ends 46a and 50a. A seal 34a is formed between overlapping portions of the first ends 44a and 46a of the first and second sides 22a and 24a, respectively, of the sidewall 12a, and a seal 36a is formed between the overlapping portions of the second ends 48a and 50a of the first and second sides 22a and 24a, respectively, of the sidewall 12a. First and second layers of material 40a and 42a of the liquid impermeable sleeve 10a are melted at the overlapping portions so as to form strong lap seals 34a and 36a, as opposed to the weld seals 34 and 36 of the sidewall 12 of the liquid impermeable sleeve 10, as depicted in FIG. 2. In forming the lap seal 34a, the first end 44a of the first side 22a of the sidewall 12a overlaps the first end 46a of the second side 24a of the sidewall 12a of the liquid impermeable sleeve 10a such that the first end 46a of the second side 24a of the sidewall 12a of the liquid impermeable sleeve 10a is disposed interior. In forming the lap seal 36a, the second end 48a of the first side 22a of the sidewall 12a overlaps the second end 50a of the second side 24a of the sidewall 12a of the liquid impermeable sleeve 10a such that the second end 50a of the second side 24a of the sidewall 12a of the liquid impermeable sleeve 10a is disposed interior.

Shown in FIG. 4B is a cross-sectional view of another embodiment of a liquid impermeable sleeve designated by the reference numeral 10b. The liquid impermeable sleeve 10b is substantially similar to the liquid impermeable sleeve 10a depicted in FIG. 4A, except that in forming a lap seal 36b, a second end 50b of a second side 24b of a sidewall 12b of the liquid impermeable sleeve 10b overlaps a second end 48b of a first side 22b of the sidewall 12b of the liquid impermeable sleeve 10b such that the second end 48b of the first side 22b of the sidewall 12b of the liquid impermeable sleeve 10b is disposed interior. A lap seal 34b is formed in the same manner as described in detail above for the lap seal 34a of the liquid impermeable sleeve 10a. That is, a first end 44b of the first side 22b of the sidewall 12b overlaps a first end 46b of the second side 24b of the sidewall 12b of the liquid impermeable sleeve 10b such that the first end 46b of the second side 24b of the sidewall 12b of the liquid impermeable sleeve 10b is disposed interior.

While two configurations of lap seals are depicted in FIGS. 4A and 4B, it will be understood that the sleeves of the present invention may also include lap seals having other configurations known in the art. For example, a liquid impermeable sleeve could be constructed which is substantially similar to the liquid impermeable sleeve 10a of FIG. 4A, except that in forming the lap seals 34a and 36a, the first and second ends 46a and 50a of the second side 24a of the sidewall 12a are disposed interior to the first and second ends 44a and 48a of the first side 22a, respectively, of the sidewall 12a of the liquid impermeable sleeve 10a in the lap seals 34a and 36a, respectively (not shown).

Shown in FIG. 5 is another embodiment of a liquid impermeable sleeve designated by the reference numeral 10c. The liquid impermeable sleeve 10c is similar to the liquid impermeable sleeves 10, 10a and 10b described in detail above and depicted in FIGS. 2, 4A and 4B, except as described hereinbelow. The liquid impermeable sleeve 10c is provided with a sidewall 12c comprising a first side 22c having first and second ends 44c and 48c and a second side 24c having first and second ends 46c and 50c. A seal 34c is formed between the adjacent portions of the first ends 44c and 46c of the first and second sides 22c and 24c, respectively, of the sidewall 12c, and a seal 36c is formed between the adjacent portions of the second ends 48c and 50c of the first and second sides 22c and 24c, respectively, of the sidewall 12c. A second layer of material 42c of the liquid impermeable sleeve 10c is melted so as to form strong fin seals 34c and 36c, as opposed to the weld seals depicted in FIG. 2 or the lap seals depicted in FIGS. 4A and 4B. A first layer of material 40c may also be melted and contribute to the forming of the fin seals 34c and 36c, or the first layer of material 40c may melt at a higher temperature and not be melted at the temperature utilized to form the fin seals 34c and 36c but still contributes to the liquid impermeability of the liquid impermeable sleeve 10c by virtue of being laminated to the second layer of material 42c.

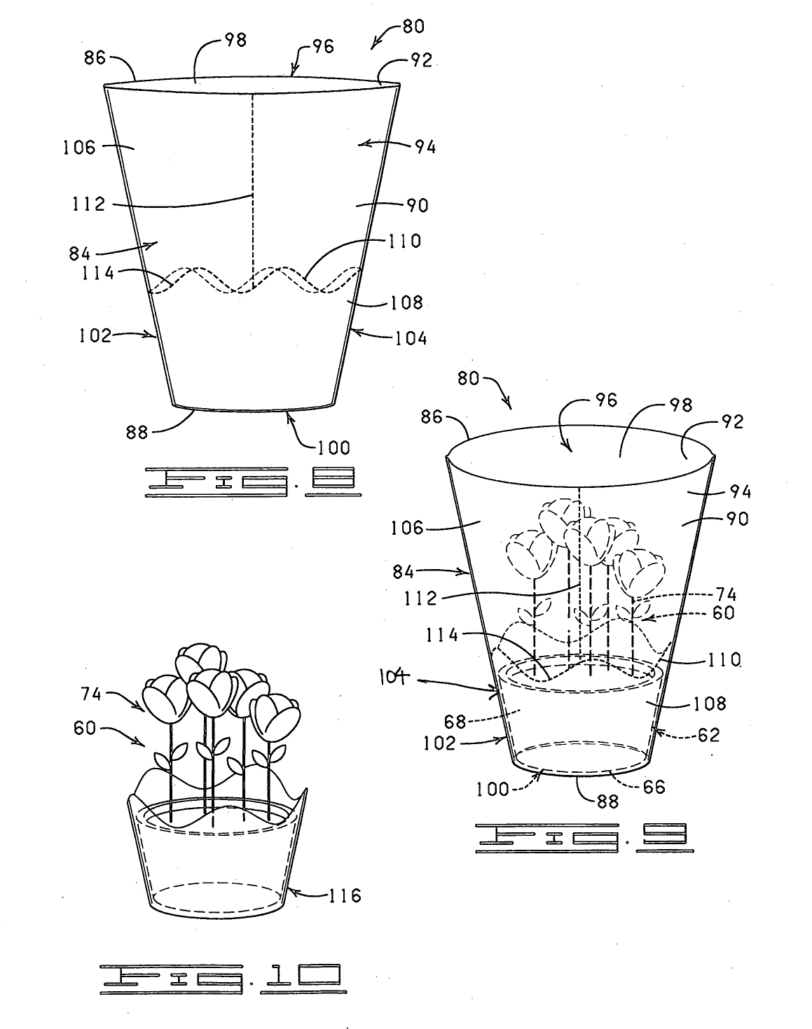

Shown in FIG. 6 and designated by the reference numeral 10d is another embodiment of a liquid impermeable sleeve. The liquid impermeable sleeve 10d is similar to the liquid impermeable sleeves 10, 10a, 10b and 10c described in detail above and depicted in FIGS. 2, 4A, 4B and 5, except as described hereinbelow. The liquid impermeable sleeve 10d is provided with a sidewall 12d comprising a first side 22d having first and second ends 44d and 48d and a second side 24d having first and second ends 46d and 50d. A butt seal 34d is formed between adjacent portions of the first ends 44d and 46d of the first and second sides 22d and 24d, respectively, of the sidewall 12d, and a butt seal 36d is formed between adjacent portions of the second ends 48d and 50d of the first and second sides 22d and 24d, respectively, of the sidewall 12d. The sheet of liquid impermeable material from which the liquid impermeable sleeve 10d is constructed is melted so as to form strong butt seals 34d and 36d, as opposed to the weld seals depicted in FIG. 2, the lap seals depicted in FIGS. 4A and 4B or the fin seals depicted in FIG. 5.

Shown in FIG. 7 and designated by the reference numeral 10e is another embodiment of a liquid impermeable sleeve. The liquid impermeable sleeve 10e is similar to the liquid impermeable sleeves 10, 10a, 10b, 10c and 10d described in detail above and depicted in FIGS. 2, 4A, 4B, 5 and 6 except as described hereinbelow. The liquid impermeable sleeve 10e is provided with a sidewall 12e comprising a first side 22e having first and second ends 44e and 48e and a second side 24e having first and second ends 46e and 50e. A seal 34e is formed between adjacent portions of the first ends 44e and 46e of the first and second sides 22e and 24e, respectively, of the sidewall 12e, and a seal 36e is formed between adjacent portions of the second ends 48e and 50e of the first and second ends 22e and 24e, respectively, of the sidewall 12e. Seal 34e of the liquid impermeable sleeve 10e is sealed with a zipper 52 and seal 36e of the liquid impermeable sleeve 10e is sealed with a zipper 54. The zippers 52 and 54 allow the liquid impermeable sleeve 10e to be partially opened and closed, such as for drainage of fluid retained therein or for greater access to the floral grouping or flower pot disposed therein, without removal of the liquid impermeable sleeve 10e from its position disposed about a floral grouping or flower pot.

It will be understood that any combination of the seals depicted in FIGS. 2, 4A, 4B and 5-7 may be employed in forming the seals 32-32e of the closed lower ends 16-16e and in seals 34-34e and 36-36e of the sidewalls 12-12e of the liquid impermeable sleeves 10-10e. For example, the seal 32 of the closed lower end 16 of the liquid impermeable sleeve 10 may be a weld seal, while the seals 34 and 36 of the sidewall 12 may each be fin seals. In addition, each of the seals 32, 34 and 36 may contain more than one seal, and the two or more seals may be of the same or different types. For example, the seal 32 in the closed lower end 16 of the liquid impermeable sleeve 10 may be sealed with a double weld seal, or may contain both weld and fin seals, so as to create a double sealed area. This would provide multiple barriers to leakage and would provide additional strength to the seal 32 of the closed lower end 16 and to the seals 34 and 36 of the sidewall 12 of the liquid impermeable sleeve 10.

Description of FIGS. 8-11

Illustrated in FIGS. 8 and 9 and designated therein by the reference numeral 80 is another embodiment of a liquid impermeable sleeve for a potted plant, which is similar to the liquid impermeable sleeve 10. The liquid impermeable sleeve 80, which is formed of a sheet of liquid impermeable material, is provided with a sidewall 84, an open upper end 86 and a closed lower end 88. The sidewall 84 is characterized as having an outer surface 90 and an inner surface 92 and comprises a first side 94 and a second side 96. The liquid impermeable sleeve 80 is shown in a substantially flattened state in FIG. 8 and is openable to an open state, as shown in FIG. 9. In the open state, an inner retaining space 98 is provided in the sleeve 80 wherein a floral grouping or flower pot may be disposed. The inner retaining space 98 is surrounded by the inner surface 92 of the sidewall 84 and is accessible through the open upper end 86 of the sleeve 80. The closed lower end 88 of the liquid impermeable sleeve 80 may be provided with one or more gussets (not shown) formed therein. When the sleeve 80 contains a gusset, the gusset may be similar to any of the gussets described herein. The closed lower end 88 of the liquid impermeable sleeve 80 is held together by a seal 100, while the sidewall 84 of the liquid impermeable sleeve 80 is held together by seals 102 and 104. The seals 100, 102 and 104 may be any of the types of seals described hereinbefore with reference to the sleeves 10-10e of FIGS. 2, 4A, 4B and 5-7.

The liquid impermeable sleeve 80 further comprises an upper portion 106 and a lower portion 108. The upper portion 106 is detachable from the lower portion 108 via a detaching element 110 which enables the detachment of the upper portion 106 of the sleeve 80 from the lower portion 108 of the sleeve 80. Preferably, the detaching element 110 is a plurality of perforations in a non-linear line, such as a crenulated, wavy, or curved pattern such as a plurality of scallops or one single curve, which extends circumferentially around the sidewall 84 of the liquid impermeable sleeve 80. However, it will be understood that the detaching element 110 may also be a straight or arcuate line of perforations. The upper portion 106 of the liquid impermeable sleeve 80 may optionally have an additional detaching element 112, indicated as a plurality of vertical perforations in FIGS. 8 and 9, for facilitating the removal of the upper portion 106 and which are disposed more or less vertically therein extending between the detaching element 110 and the upper end 86 of the liquid impermeable sleeve 80. The upper portion 106 of the liquid impermeable sleeve 80 is separable from the lower portion 108 of the liquid impermeable sleeve 80 by tearing the upper portion 106 along both the detaching elements 110 and 112.

The term “detaching element” as used generally herein means any element or combination of elements or features such as perforations, tear strips, zippers, and any other devices or elements of this nature known in the art, or any combination thereof, which enable the tearing away or detachment of one object from another. Therefore, while perforations are shown and described in detail herein, it will be understood that tear strips, zippers, or any other “detaching elements” known in the art, or any combination thereof, could be substituted therefor and/or used therewith.

The lower portion 108 is provided with an upper end 114 which is congruent with the detaching element 110. The lower portion 108 of the liquid impermeable sleeve 80 is tapered from the closed lower end 16 of the sleeve toward a larger diameter at the upper end 114 of the lower portion 108 and sized to substantially surround and encompass the outer peripheral surface 68 of the flower pot 62 of the potted plant 60, while the upper portion 106 of the liquid impermeable sleeve 80 is sized to substantially surround and encompass the floral grouping or plant 74 disposed within the flower pot 62 to form the potted plant 60.

The sheet of liquid impermeable material from which the liquid-impermeable sleeve 80 is constructed is substantially similar to the sheet of liquid impermeable material hereinbefore described with reference to the liquid impermeable sleeve 10, and the liquid impermeable sleeve 80 is constructed in a similar manner as described herein previously for the liquid impermeable sleeve 10. In addition, the upper portion 106 and the lower portion 108 of the liquid impermeable sleeve 80 may be constructed of different materials, and the upper and lower portions 106 and 108 of the liquid impermeable sleeve 80 may be liquid impermeable, or only the lower portion 108 of the liquid impermeable sleeve 80, which is adapted to contain the flower pot 62, may be liquid impermeable. For example, the portion of the sheet of liquid impermeable material which forms the upper portion 106 of the liquid impermeable sleeve 80 may be constructed of a material which is weaker or more transparent than the portion of the sheet of liquid impermeable material which forms the lower portion 108 of the liquid impermeable sleeve 80, since the lower portion 108 of the liquid impermeable sleeve 80 must support the weight of the potted plant 60 as well as retain any liquid which might leak or drain from the potted plant 60, whereas the upper portion 106 of the liquid impermeable sleeve 80 may not be required to contain liquid and therefore may only need to contribute to the decorative appearance of the liquid impermeable sleeve 80 or protect the floral grouping 74 of the potted plant 60. Alternatively, the sheet of liquid impermeable material may contain a layer of polymeric film, and the portion of the sheet of liquid impermeable material which forms the lower portion 108 of the sleeve 80 may contain a second layer of material while the portion of the sheet of liquid impermeable material which forms the upper portion 106 of the sleeve 80 contains a single layer of the polymeric film.

In addition, at least one of the upper and lower portions 106 and 108 of the liquid impermeable sleeve 80 may be provided with decorative patterns, such as printed and/or embossed patterns, disposed thereon. The upper and lower portions 106 and 108 of the liquid impermeable sleeve 80 may be provided with the same or different patterns disposed thereon, or only one of the upper and lower portions 106 and 108 of the liquid impermeable sleeve 80 may be provided with a pattern disposed thereon. For example, the lower portion 108 of the liquid impermeable sleeve 80 may be provided with a printed and/or embossed pattern thereon, while the upper portion 106 of the liquid impermeable sleeve 80 is free of a printed or embossed pattern. In a preferred embodiment, the upper portion 106 of the liquid impermeable sleeve 80 is formed of a transparent material and the lower portion 108 has a printed and/or embossed pattern disposed thereon.

In a method of use of the liquid impermeable sleeve 80, as shown in FIGS. 8-10, the sleeve 80 is opened to an open position and the potted plant 60 is placed within the inner retaining space 98 of the liquid impermeable sleeve 80 such that the lower portion 108 of the liquid impermeable sleeve 80 substantially surrounds and encompasses the flower pot 62 while the upper portion 106 of the liquid impermeable sleeve 80 substantially surrounds the floral grouping or plant 74 disposed within the flower pot 62. The closed lower end 88 of the liquid impermeable sleeve 80 preferably conforms to the curvature of the circumference of the lower end 66 of the flower pot 62.

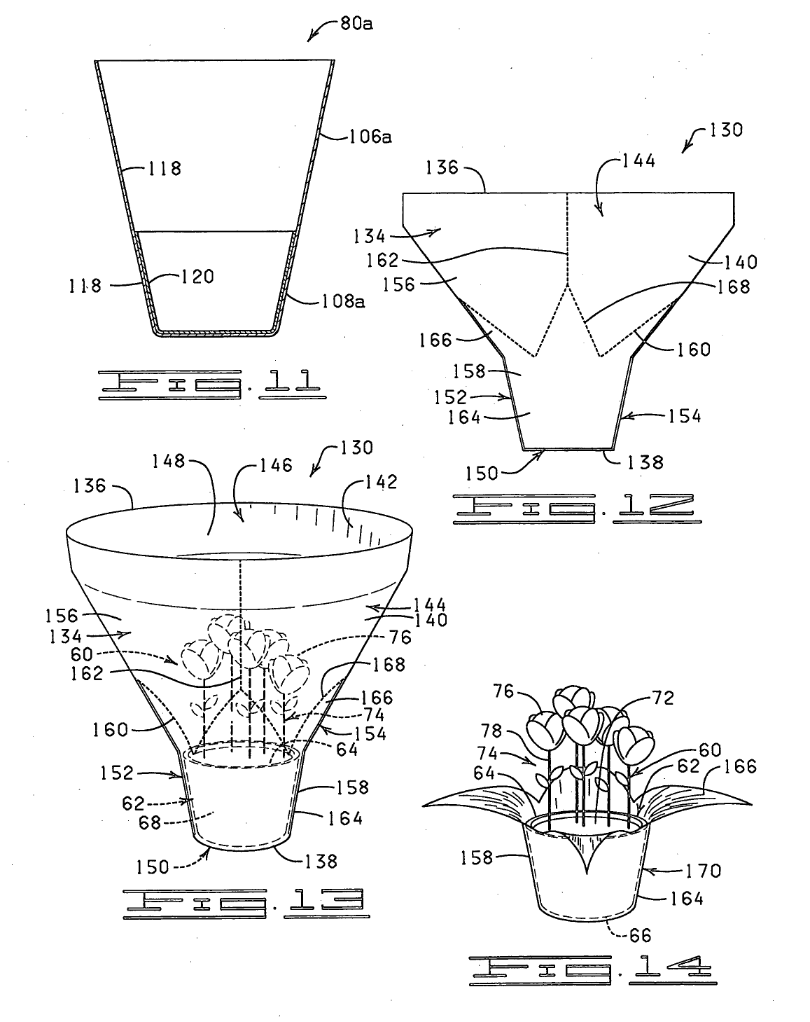

When it is desired to remove the upper portion 106 of the liquid impermeable sleeve 80, the upper portion 106 is removed from the lower portion 108 of the liquid impermeable sleeve 80 via the detaching elements 110 and 112. Upon removal of the upper portion 106 of the liquid impermeable sleeve 80, the lower portion 108 of the liquid impermeable sleeve 80 remains positioned about the potted plant 60, thereby forming a decorative cover 116 for the potted plant 60, as shown in FIG. 10. The decorative cover 116 substantially surrounds and encompasses the flower pot 62 and at least a portion of the floral grouping 74 disposed therein.

Shown in FIG. 11 is another embodiment of a liquid impermeable sleeve designated by the reference numeral 80a, which is similar to the liquid impermeable sleeve 80 hereinbefore described and illustrated in FIGS. 8-10, except that the an upper portion 106a of the liquid impermeable sleeve 80a is formed of a single layer of material while a lower portion 108a of the liquid impermeable sleeve 80a is provided with an additional layer of material (in addition to the single layer of material also provided in the upper portion 106a) which lines an inner surface of the liquid impermeable sleeve 80a. That is, the portion of a sheet of liquid impermeable material which forms the upper portion 106a of the sleeve 80a contains a single layer of material 118, while the portion of the sheet of liquid impermeable material which forms the lower portion 108a of the sleeve 80a contains two layers which include the layer of material 118 and a second layer of material 120 laminated thereto.

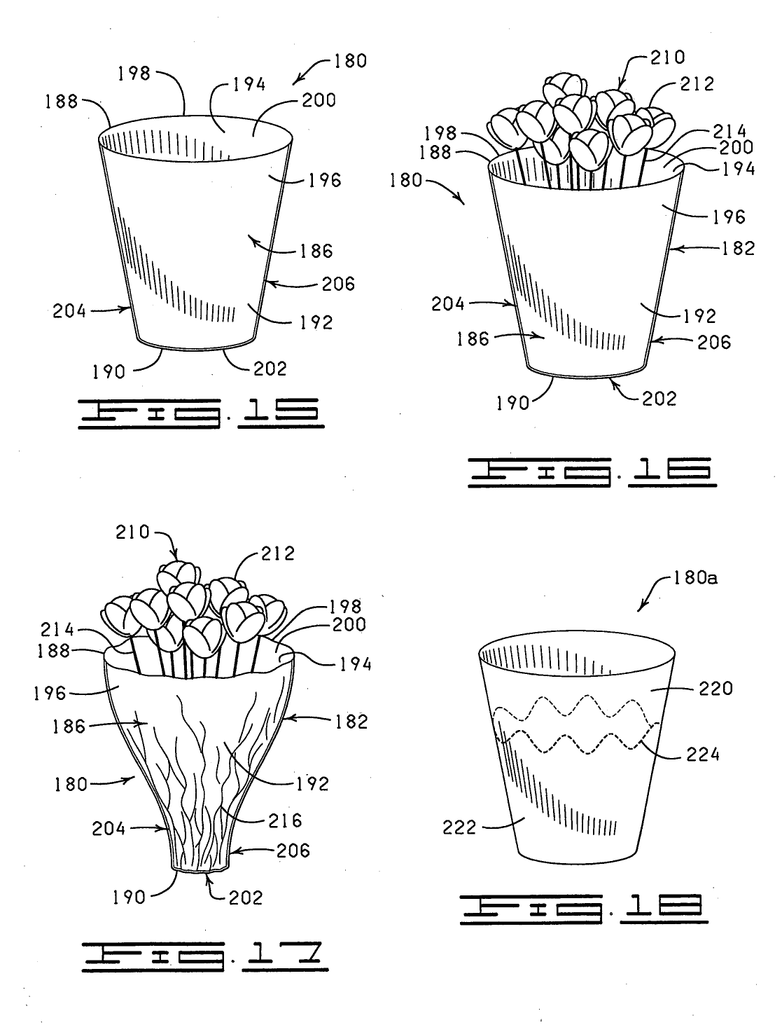

Description of FIGS. 12-14

Shown in FIG. 12 and designated therein by the reference numeral 130 is yet another embodiment of a liquid impermeable sleeve, which is similar to the liquid impermeable sleeves 10-10e, 80 and 80a described in detail hereinbefore with reference to FIGS. 1-11. The liquid impermeable sleeve 130, which is formed of a sheet of liquid impermeable material, is provided with a sidewall 134, an open upper end 136 and a closed lower end 138. The sidewall 134 is characterized as having an outer surface 140 and an inner surface 142 and comprises a first side 144 and a second side 146. The liquid impermeable sleeve 130 is openable to an open state, wherein an inner retaining space 148 is provided in the sleeve 130 wherein a floral grouping or flower pot may be disposed. The inner retaining space 148 is surrounded by the inner surface 142 of the sidewall 134 and is accessible through the open upper end 136 of the sleeve 130. The closed lower end 138 of the liquid impermeable sleeve 130 may be provided with one or more gussets (not shown) formed therein. When the sleeve 130 is provided with a gusset therein, the gusset is substantially similar to the gusset 24 of liquid impermeable sleeve 10 shown in FIG. 1 and described in detail hereinbefore. The closed lower end 138 is held together by a seal 150, while the sidewall 134 is held together by the seals 152 and 154. The seals 150, 152 and 154 may be any of the types of seals as described in detail hereinbefore in reference to the sleeves 10-10e shown in FIGS. 2, 4A, 4B and 5-7.

The liquid impermeable sleeve 130 further comprises an upper portion 156 and a lower portion 158, wherein the upper portion 156 is detachable from the lower portion 158 via a detaching element 160 similar to the detaching element 110 hereinbefore described with reference to the sleeve 80 shown in FIGS. 8 and 9 and optionally a vertical detaching element 162 similar to the detaching element 112 hereinbefore described with reference to the sleeve 80 shown in FIGS. 8 and 9. In addition, the lower portion 158 of the liquid impermeable sleeve 130 further comprises a base portion 164 and a skirt portion 166. The base portion 164 is that part of the lower portion 158 which, when the flower pot 62 is placed in to the liquid impermeable sleeve 130, is substantially adjacent to and surrounds the outer peripheral surface 68 of the flower pot 62. The skirt portion 166 of the lower portion 158 of the liquid impermeable sleeve 130 is that part of the lower portion 158 which extends beyond the upper end 64 of the flower pot 62 and surrounds at least a lower portion of the floral grouping or plant 74 disposed within the flower pot 62 and which is left to freely extend at an angle, inwardly or outwardly or upwardly, from the base portion 164 of the lower portion 158 when the upper portion 156 of the liquid impermeable sleeve 130 is detached from the lower portion 158 of the sleeve 130 via the detaching elements 160 and 162. Prior to removal of the upper portion 156 of the liquid impermeable sleeve 130, an upper end 168 of the skirt portion 166 of the lower portion 158 of the sleeve 130 is congruent with the detaching element 160, and is positioned near the upper end 64 of the flower pot 62 when the flower pot 62 is disposed in the lower portion 158 of the liquid impermeable sleeve 130.

The sheet of liquid impermeable material employed in the construction of the liquid impermeable sleeve 130 will be similar to the sheet of liquid impermeable material employed in the construction of the liquid impermeable sleeve 10 described hereinabove, and the liquid impermeable sleeve 130 will be constructed in a similar manner as described herein previously for the liquid impermeable sleeves 10 and 80 shown in FIGS. 1 and 8. In addition, not only may the upper portion 156 and the lower portion 158 of the liquid impermeable sleeve 130 be constructed of different materials, but the base portion 164 and the skirt portion 166 of the lower portion 158 of the liquid impermeable sleeve 130 may be constructed of different materials. For example, the base portion 164 of the lower portion 158 of the liquid impermeable sleeve 130 may be liquid impermeable, while the skirt portion 166 of the lower portion 158 of the liquid impermeable sleeve 130 may not. For example, this may be accomplished by forming the base portion 164 of a laminate of two layers and the skirt portion 166 of a single layer of material, which may be constructed in a similar manner as the sleeve 80a of FIG. 11 hereinbefore described, wherein the lower portion 108a of the sleeve 80a is formed of a laminate while the upper portion 106a of the sleeve 80a is single-layered. Also, one or both of the base portion 164 and the skirt portion 166 may be multilayered as described herein previously. Multilayers in the skirt portion 166 could be used to provide additional decorative characteristics to the decorative cover 170 (FIG. 14) formed upon detachment of the upper portion 156 of the sleeve 130.

In a method of use, as shown in FIGS. 12-14, the sleeve 130 is opened to an open state and the potted plant 60 is placed within the inner retaining space 148 of the liquid impermeable sleeve 130 such that the lower portion 158 of the liquid impermeable sleeve 130 substantially surrounds and encompasses the flower pot 62 while the upper portion 156 of the liquid impermeable sleeve 130 substantially surrounds the floral grouping or plant 74 disposed within the flower pot 62. The closed lower end 138 of the liquid impermeable sleeve 130 substantially conforms to the curvature of the circumference of the lower end 66 of the flower pot 62.

When it is desired to remove the upper portion 156 of the liquid impermeable sleeve 130, the upper portion 156 is removed from the lower portion 158 of the liquid impermeable sleeve 130 via the detaching elements 160 and 162. Upon removal of the upper portion 156 of the liquid impermeable sleeve 130, the base portion 164 and skirt portion 166 of the lower portion 158 of the liquid impermeable sleeve 130 remain positioned about the potted plant 60, thereby forming a decorative cover 170 for the potted plant 60, as shown in FIG. 14. The base portion 164 of the lower portion 158 of the liquid impermeable sleeve 130 substantially surrounds and encompasses the flower pot 62, and the skirt portion 166 of the lower portion 158 of the liquid impermeable sleeve 130 extends therefrom and remains disposed about at least a portion of the floral grouping 74 disposed therein.

It is to be understood that the present invention also includes the decorative cover 170, wherein the liquid impermeable sleeve 130 is only provided with the lower portion 158 thereof and is free of the upper portion 156 thereof.

Embodiments of FIGS. 15-20

Illustrated in FIG. 15 and designated herein by the reference numeral 180 is a liquid impermeable sleeve for forming a wrapper 182 about a floral grouping, which is similar to the liquid impermeable sleeves 10-10e, 80-80a and 130 described in detail previously, except as described hereinafter.

The liquid impermeable sleeve 180, which is formed of a sheet of liquid impermeable material, is provided with a sidewall 186, an open upper end 188 and a closed lower end 190. The sidewall 186 is characterized as having an outer surface 192 and an inner surface 194 and comprises a first side 196 and a second side 198. The liquid impermeable sleeve 180 is openable to an open state, wherein an inner retaining space 200 is provided in the sleeve 180 wherein a floral grouping or flower pot may be disposed. The inner retaining space 200 is surrounded by the inner surface 194 of the sidewall 186 and is accessible through the open upper end 188 of the sleeve 180. The closed lower end 190 of the liquid impermeable sleeve 180 may be provided with one or more gussets (not shown) formed therein. When the sleeve 180 is provided with a gusset, the gusset will be similar to the gusset 24 of liquid impermeable sleeve 10 hereinbefore described with reference to FIG. 1. The closed lower end 190 of the sleeve 180 is held together by a seal 202 therein, while the sidewall 186 is held together by seals 204 and 206. The seals 202, 204 and 206 may be any of the types of seals hereinbefore described with reference to the sleeves 10-10e shown in FIGS. 2, 4A, 4B and 5-7.

The sheet of liquid impermeable material from which the liquid impermeable sleeve 180 is constructed will be similar to the sheet of liquid impermeable material employed in the construction of the liquid impermeable sleeve 10 described hereinbefore, and the liquid impermeable sleeve 180 will be constructed in the same manner as described herein previously for the liquid impermeable sleeves 10-10e, 80-80a and 130.

In a method of use of the sleeve 180, the sleeve 180 is opened to an open state and a floral grouping 210 having a bloom portion 212 and a stem portion 214 is disposed through the open upper end 188 and into the inner retaining space 200 of the liquid impermeable sleeve 180, as shown in FIG. 16. The floral grouping 210 is positioned in the liquid impermeable sleeve 180 such that the stem portion 214 of the floral grouping 210 is substantially surrounded by and encompassed in the inner retaining space 200 of the liquid impermeable sleeve 180, thereby providing the wrapper 182 for the floral grouping 210 wherein the wrapper 182 is liquid impermeable. The bloom portion 212 of the floral grouping 210 may be disposed in the inner retaining space 200 of the sleeve 180, or the bloom portion 212 of the floral grouping 210 may be disposed substantially adjacent the open upper end 188 of the sleeve 180, or the bloom portion 212 of the floral grouping 210 may be disposed above the open upper end 188 of the sleeve 180.

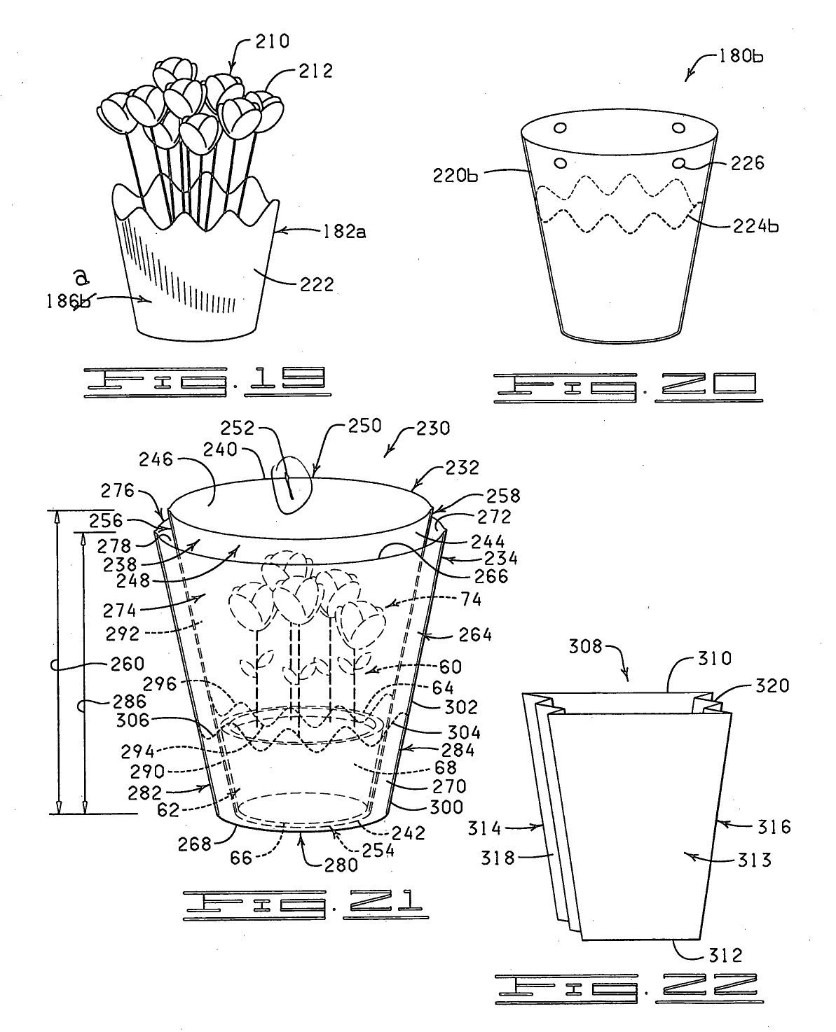

As shown in FIG. 17, the wrapper 182 formed from the liquid impermeable sleeve 180 may further be crimped about the stem portion 214 of the floral grouping 210 to secure the sleeve 180 about the floral grouping 210. The crimping operation is conducted after the floral grouping 210 is disposed in the sleeve 180 by crimping at least a portion of the sleeve 180 about a portion of the stem portion 214 of the floral grouping 210. Such crimping may be conducted by hand, by grasping and substantially encompassing with one or more hands a portion of the sleeve 180 and squeezing that portion of the sleeve 180 about the stem portion 214 of the floral grouping 210. The sleeve 180 may also be crimped by using both a crimping motion (as described above) and a turning motion to create a twisted crimping, resulting in a wrapper 182 which is both crimped and twisted about at least a portion of the stem portion 214 of the floral grouping 210.

When the wrapper 182 formed from the sleeve 180 is crimped, a plurality of overlapping folds 216 are formed in the crimped area. The plurality of overlapping folds 216 may be connected together, such as via a bonding material (not shown) disposed upon a portion of the outer surface 192 and/or inner surface 194 of the sleeve 180. Alternatively, the sleeve 180 may be secured in the crimped position by a band or tie (not shown).

Shown in FIG. 18 is another embodiment of a liquid impermeable sleeve designated by the reference numeral 180a, which is substantially similar to the liquid impermeable sleeve 180 hereinbefore described with reference to FIGS. 15-17, except that the liquid impermeable sleeve 180a further comprises an upper portion 220, a lower portion 222, and a detaching element 224, such as a non-linear line of perforations as illustrated in FIG. 18, for permitting the upper portion 220 to be selectively removed from the lower portion 222 of the sleeve 180a. The liquid impermeable sleeve 180a is constructed of the same materials and in the same manner as the liquid impermeable sleeve 180. The method of use of the liquid impermeable sleeve 180a to form a wrapper 182a is similar to that of the liquid impermeable sleeve 180 in forming a wrapper 182, except that the upper portion 220 of the liquid impermeable sleeve 180a may be removed from the lower portion 222 of the liquid impermeable sleeve 180a, thereby exposing the bloom portion 212 of the floral grouping 210, as shown in FIG. 19.

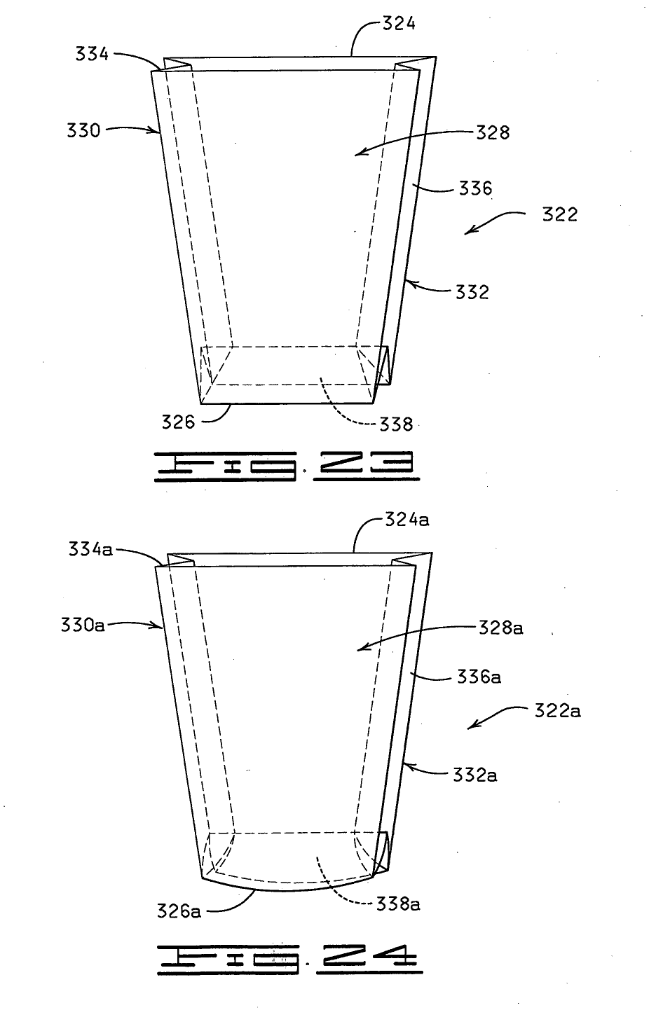

Shown in FIG. 20 is another embodiment of the liquid impermeable sleeve designated by the reference numeral 180b, which is similar to the liquid impermeable sleeve 180a shown in FIG. 18 and described in detail herein above, except that an upper portion 220b of the liquid impermeable sleeve 180b is provided with one or more apertures 226 disposed therein above a detaching element 224b of the liquid impermeable sleeve 180b. The apertures 226 permit the liquid impermeable sleeve 180b, or a wrapper 182b formed therefrom and containing a floral grouping disposed therein, to be placed on a rod or a set of rods, also known as wickets (not shown), for shipment, storage, assembly of the wrapper 182b, or other function known in the art.

While only the liquid impermeable sleeve 180b is depicted as containing apertures 226, it will be understood that any of the upper portions of any of the liquid impermeable sleeves described herein, such as the upper portions 106 and 156 of the liquid impermeable sleeves 80 and 130, respectively, may be provided with apertures therein for permitting the liquid impermeable sleeves 80 and 130 to be utilized in a similar manner.

Embodiment of FIG. 21

Illustrated in FIG. 21 and designated by the reference numeral 230 is a liquid impermeable plant package for the potted plant 60, the liquid impermeable plant package 230 comprising a first sleeve 232 and a second sleeve 234.

The first sleeve 232 is similar to the liquid impermeable sleeves 10-10e, 80-80a, 130 and 180 described in detail previously, except as described hereinafter. The first sleeve 232 is formed of a sheet of liquid impermeable material and is provided with a sidewall 238, an open upper end 240 and a lower end 242. The sidewall 238 is characterized as having an outer surface 244 and an inner surface 246 and comprises a first side 248 and a second side 250. The first sleeve 232 is openable to an open state, wherein an inner retaining space 252 is provided in the first sleeve 232 in which a floral grouping or flower pot may be disposed. The inner retaining space 252 is surrounded by the inner surface 246 of the sidewall 238 and is accessible through the open upper end 240 of the first sleeve 232. The lower end 242 of the first sleeve 232 may be closed, and is held together by a seal 254 when closed. The sidewall 238 of the first sleeve 232 is held together by seals 256 and 258 therein. The first sleeve 232 has a height 260 which extends between the upper end 240 and lower end 242 thereof, and is tapered from the lower end 242 thereof toward a larger diameter at the upper end 240 thereof such that when a potted plant is disposed therein, the first flexible sleeve 232 is substantially adjacent to and substantially surrounds and encompasses the potted plant.

The second sleeve 234 is similar to the first sleeve 232 described hereinabove. The second sleeve 234, which is formed of a sheet of liquid impermeable material, is provided with a sidewall 264, an open upper end 266 and a lower end 268. The sidewall 264 is characterized as having an outer surface 270 and an inner surface 272 and comprises a first side 274 and a second side 276. The second sleeve 234 is openable to an open state, wherein an inner retaining space 278 is provided in the second sleeve 234 wherein the first sleeve 232 may be disposed. The inner retaining space 278 is surrounded by the inner surface 272 of the sidewall 264 and is accessible through the open upper end 266 of the second sleeve 234. The lower end 268 of the second sleeve 234 may be closed, and when closed is held together by a seal 280. The sidewall 264 of the second sleeve 234 is held together by seals 282 and 284 therein. The second sleeve 234 has a height 286 which extends between the upper end 266 and lower end 268 thereof, and is tapered from the lower end 268 thereof toward a larger diameter at the upper end 266 thereof.

The first sleeve 232 is disposed within the inner retaining space 278 of the second sleeve 234 such that the lower end 242 of the first sleeve 232 is substantially adjacent to the lower end 268 of the second sleeve 234, thereby forming the liquid impermeable plant package 230 which has at least a portion which is multilayered. When the lower ends 242 and 268 of the first and second sleeves 232 and 234, respectively, are not closed prior to disposal of the first sleeve 232 into the second sleeve 234, the lower ends 242 and 268 may be sealed simultaneously after the first sleeve 232 is disposed within the inner retaining space 278 of the second sleeve 234, thereby attaching the first and second sleeves 232 and 234 and forming a closed lower end of the liquid impermeable plant package-230.

The sheets of liquid impermeable material from which the first and second sleeves 232 and 234 are constructed are similar to the sheet of liquid impermeable material employed in the construction of the liquid impermeable sleeve 10 hereinbefore described, and the first and second sleeves 232 and 234 are constructed in the same manner as described herein previously for the liquid impermeable sleeves 10-10e, 80, 80a, 130 and 180-180b. So that the plant package 230 formed therefrom is liquid impermeable, at least one of the sheets of liquid impermeable material from which the first and second sleeves 232 and 234 of the liquid impermeable plant package 230 are constructed is formed of a material which is liquid impermeable, and the seals 254, 256 and 258 of the first sleeve 232 and/or the seals 282, 284 and 286 of the second sleeve 234 are liquid impermeable as described in detail above in reference to the seals 32, 34 and 36 of the liquid impermeable sleeve 10 as shown in FIGS. 1 and 2. The seals 254, 256, 258, 282, 284 and 286 may be any of the types of seals hereinbefore described with reference to the sleeves 10-10e of FIGS. 2, 4A, 4B and 5-7.

When forming the liquid impermeable plant package 230, the height 260 of the first sleeve 232 and the height 286 of the second sleeve 234 may be substantially the same so that the upper end 240 of the first sleeve 232 is substantially adjacent to the upper end 266 of the second sleeve 234, and the plant package 230 formed therefrom is multilayered. Alternatively, the height 260 of the first sleeve 232 may be less than the height 286 of the second sleeve 234 such that only a portion of the liquid impermeable plant package 230 is multilayered.

The first sleeve 232 may further comprise a lower portion 290 and an upper portion 292 which is detachable from the lower portion 290 via a detaching element 294, such as the non-linear line of perforations illustrated in FIG. 21. The lower portion 290 is sized and tapered to substantially surround and encompass the outer peripheral surface 68 of the flower pot 62 disposed therein, while the upper portion 292 is sized to substantially surround and encompass the floral grouping or plant 74 disposed in the flower pot 62. Upon detachment of the upper portion 292, the lower portion 290 of the first sleeve 232 is provided with an upper edge 296 which is congruent with the detaching element 294. The upper edge 296 of the lower portion 290 of the first sleeve 232 may be provided with a decorative appearance, such as a pattern.

The second sleeve 234 may also further comprise a lower portion 300 and an upper portion 302 which is detachable from the lower portion 300 via a detaching element 304, such as the non-linear line of perforations illustrated in FIG. 21. Upon detachment of the upper portion 302, the lower portion 300 is provided with an upper edge 306 which is congruent with the detaching element 304. The upper edge 306 of the lower portion 300 of the second sleeve 234 may be provided with a decorative appearance, such as a pattern. It will be understood that either or both of the upper portions 292 and 302 of the first and second sleeves 232 and 234, respectively, may be provided with one or more apertures therein (similar to the apertures 226 of sleeve 180b shown in FIG. 20 and hereinbefore described) permitting the liquid impermeable plant package 230 to be placed on a rod or wickets for shipment, storage, assembly of the liquid impermeable plant package 230, or other function known in the art (not shown).

When both the first and second sleeves 232 and 234 are provided with detachable upper portions 292 and 302, respectively, the detaching elements 294 and 304 may be substantially adjacent, so that upon removal of the upper portions 292 and 302, the upper edge 296 of the lower portion 290 of the first sleeve 232 and the upper edge 306 of the lower portion 300 of the second sleeve 234 are substantially adjacent and cooperate to provide a decorative appearance to the liquid impermeable plant package 230. Alternatively, the upper edge 296 of the lower portion 290 of the first sleeve 232 may be disposed a distance above or below the upper edge 306 of the lower portion 300 of the second sleeve 234. In FIG. 21, the upper edge 296 of the lower portion 290 of the first sleeve 232 is depicted as disposed a distance above the upper edge 306 of the lower portion 300 of the second sleeve 234. In this manner, different decorative appearances for the liquid impermeable plant package 230 can be achieved. For example, when the sheets of liquid impermeable material from which the first and second sleeves 232 and 234 are formed are two different materials having different colorings or decorative patterns thereon, a tiered effect can be achieved in this manner.

Description of FIGS. 22-24

The liquid impermeable sleeves contemplated herein may be provided with different types of gussets formed therein. The liquid impermeable sleeve 10 is illustrated in FIG. 1 as having the gusset 28 formed in the closed lower end 16 thereof. Shown in FIG. 22 is a liquid impermeable sleeve 308 similar to the liquid impermeable sleeves 10, 80, 130 and 180 previously described herein. The liquid impermeable sleeve 308 is provided with an upper end 310, a lower end 312 and a sidewall 313 having a first side 314 and a second side 316. The lower end 312 and sidewall 313 of the liquid impermeable sleeve 308 are provided with liquid impermeable seals formed therein, as described in detail herein above. The first side 314 of the sidewall 313 of the liquid impermeable sleeve 308 is provided with two gussets 318 formed therein, while the second side 316 of the sidewall 313 of the liquid impermeable sleeve 308 is provided with two gussets 320 formed therein. The gussets 318 and 320 allow for the expansion of the sidewall 313 of the liquid impermeable sleeve 308. The gussets 318 and 320 may extend the entire length of the liquid impermeable sleeve 308 from the lower end 312 to the upper end 310 thereof (substantially as shown in FIG. 22), or the gussets 318 and 320 may extend only an intermediate distance therebetween. When a flower pot and/or a floral grouping is disposed in the liquid impermeable sleeve 308, the gussets 318 and 320 may be fully expanded to accommodate the size of the flower pot or floral grouping, or the gussets 318 and 320 may continue to provide a folded appearance to the liquid impermeable sleeve 308, such as for decorative purposes or to provide a void space which may serve as a water reservoir for the flower pot or floral grouping disposed therein.

Shown in FIG. 23 is a liquid impermeable sleeve 322 similar to the liquid impermeable sleeves 10, 80, 130, 180 and 308 previously described herein. The liquid impermeable sleeve 322 is provided with an upper end 324, a lower end 326 and a sidewall 328 having a first side 330 and a second side 332. The lower end 326 and sidewall 328 of the liquid impermeable sleeve 322 are provided with liquid impermeable seals formed therein, as described in detail herein above. The first side 330 of the sidewall 328 of the liquid impermeable sleeve 322 is provided with a gusset 334 formed therein, while the second side 332 of the sidewall 328 of the liquid impermeable sleeve 322 is provided with a gusset 336 formed therein. In addition, the lower end 326 of the liquid impermeable sleeve 322 is also provided with a gusset 338 formed therein.

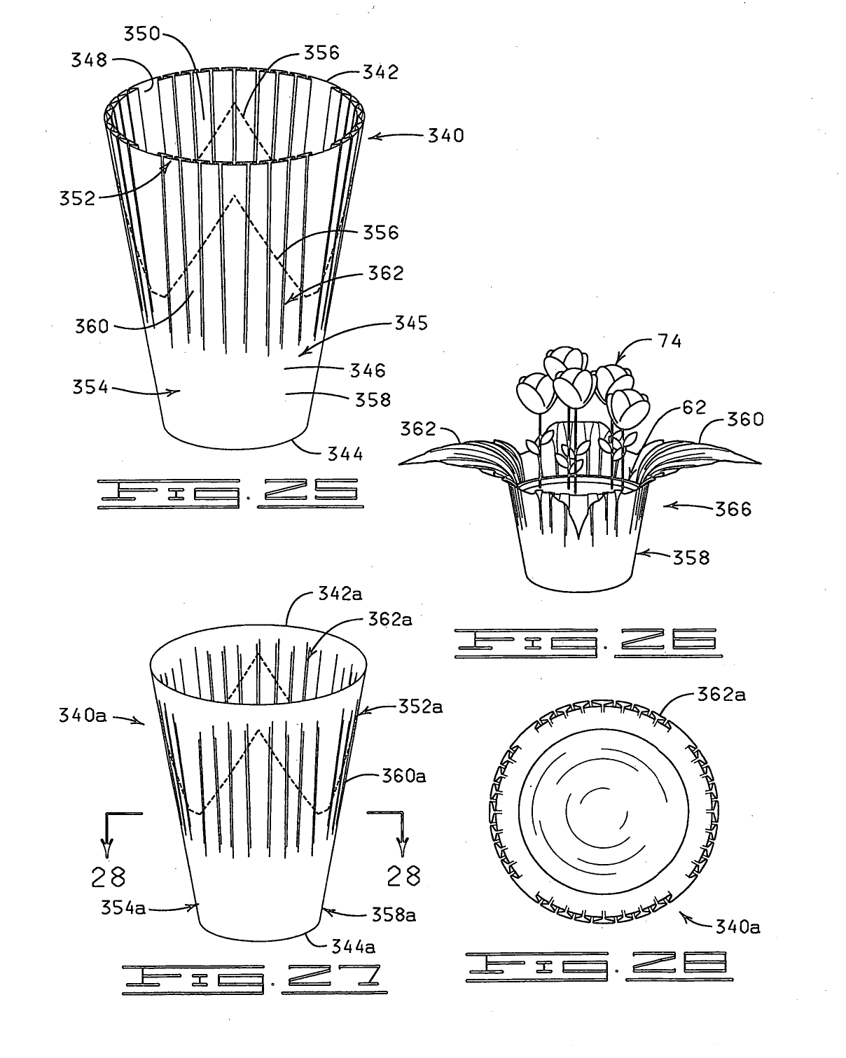

FIG. 24 illustrates a liquid impermeable sleeve 322a which is constructed in a manner similar to those of the liquid impermeable sleeve 322 of FIG. 23 except for the configuration of a lower end 326a of the liquid impermeable sleeve 322a. The liquid impermeable sleeve 322a has an upper end 324a, the lower end 326a and a sidewall 328a having a first side 330a and a second side 332a. The lower end 326a and the sidewall 328a of the liquid impermeable sleeve 322a are provided with liquid impermeable seals formed therein, as described in detail herein above. The first side 330a is provided with a gusset 334a formed therein, while the second side 332a is provided with a gusset 336a formed therein. The lower end 326a of the liquid impermeable sleeve 322a is provided with a gusset 338a formed therein. The gusset 338a has curved portions which provide the lower end 326a of the liquid impermeable sleeve 322a with the appearance of being curved when in the flattened condition and which provide the lower end 326a of the liquid impermeable sleeve 322a with a rounded configuration in the open condition (i.e., a rounded bottom) for more closely conforming to the rounded configuration of a typical round-bottom flower pot.

Other methods of forming gussets in the bottom and/or sides of a decorative cover or sleeve for a flower pot are known in the art. For example, U.S. Pat. No. 6,125,578 issued to Weder on Oct. 3, 2000, the Specification of which is hereby incorporated herein by reference, discloses other floral sleeves having gussets formed in the bottom and/or sides thereof to allow for expansion of such floral sleeves. As such the present invention is not limited only to those shown herein in view of the fact that gussets and their manufacture are well known to those of ordinary skill in the art of manufacturing bags.

Each of the liquid impermeable sleeves 308, 322 and 322a shown in FIGS. 22-24 and described herein are provided with liquid impermeable seals in the lower ends 312, 326 and 326a, respectively, thereof, and/or in the sidewalls 313, 328 and 328, respectively, thereof, as described herein before in detail with respect to the liquid impermeable sleeves 10-10e, 80, 130 and 180. The seals of the liquid impermeable sleeves 308, 322 and 322a, as well as the methods for forming such seals in the liquid impermeable sleeves 308, 322 and 322a, will be understood to be formed from any of the materials and methods described herein and will include all of the characteristics described in detail with regards to the seals of the other liquid impermeable sleeves 10-10e described herein, such as the seals 32-32e, 34-34e and 36-36e.

Description of FIGS. 25-30

Shown in FIG. 25 is a liquid impermeable sleeve 340 which is similar to the liquid impermeable sleeves 10, 80, 130 and 180 previously described herein and is provided with liquid impermeable seals (not shown) as previously described herein with reference to the liquid impermeable sleeves 10, 80, 130 and 180. The liquid impermeable sleeve 340 is provided with an upper end 342, a lower end 344, a sidewall 345 having an outer peripheral surface 346 and an inner peripheral surface 348, and an inner retaining space 350. The lower end 344 and the sidewall 345 of the liquid impermeable sleeve 340 are provided with liquid impermeable seals formed therein, as described in detail herein above.

The liquid impermeable sleeve 340 comprises an upper portion 352 and a lower portion 354. The lower portion 354 of the liquid impermeable sleeve 340 is sized to substantially cover an outer peripheral surface of a flower pot, such as the outer peripheral surface 68 of the flower pot 62 shown in FIG. 3 and substantially as illustrated in FIG. 26, while the upper portion 352 of the liquid impermeable sleeve 340 is sized to substantially surround a floral grouping disposed in the flower pot, such as the floral grouping 74 disposed in the flower pot 62 of FIG. 26. The upper portion 352 of the liquid impermeable sleeve 340 extends from and is attached to the lower portion 354 and is detachable therefrom via a detaching element 356 such as one described in detail herein above. The lower portion 354 of the liquid impermeable sleeve 340 further comprises a base portion 358 and a skirt portion 360 which are similar to and function in the same manner as the base and skirt portions 164 and 166 of the lower portion 158 of the liquid impermeable sleeve 130 as illustrated in FIGS. 12-14.

The liquid impermeable sleeve 340 is further provided with at least one expansion element 362 which is integral to at least one of the base portion 358 and the skirt portion 360 of the lower portion 354 of the liquid impermeable sleeve 340, and which may extend into the upper portion 352 of the liquid impermeable sleeve 340 as well, as shown in FIG. 25. The expansion element 362 functions to allow expansion of a portion of the skirt portion 360 of the lower portion 354 of the liquid impermeable sleeve 340 as shown in FIG. 26, wherein the skirt portion 360 extends angularly from the base portion 358 of the lower portion 354 of the liquid impermeable sleeve 340 when the upper portion 352 of the liquid impermeable sleeve 340 is detached from the skirt portion 360 of the lower portion 354 of the liquid impermeable sleeve 340 via the detaching element 356, thereby forming a decorative cover 366.

As shown in FIG. 25, each expansion element 362 of the liquid impermeable sleeve 340 comprises one or more areas of excess material shaped in the form of a pleat which extends from the base portion 358 of the lower portion 354 to the upper end 342 of the liquid impermeable sleeve 340. As used herein, the term “excess material” refers to an amount of material which has a greater surface area than would actually be necessary to form that portion of the plant covering were that portion of the plant covering actually flattened. The expansion element 362 can expand causing portions of the skirt portion 360 to extend angularly from the base portion 358 and about a portion of the floral grouping 74 disposed in the flower pot 62 as shown in FIG. 26.

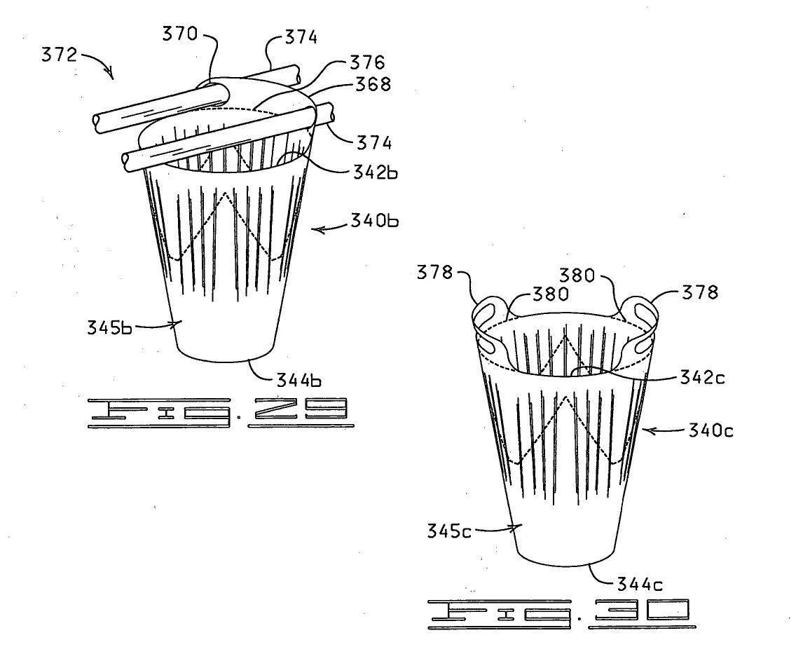

Shown in FIG. 27 is a liquid impermeable sleeve 340a which is similar to the liquid impermeable sleeve 340 except that the liquid impermeable sleeve 340a has a plurality of expansion elements 362a which do not extend from a base portion 358a of a lower portion 354a of the liquid impermeable sleeve 340a all the way to an upper end 342a of the liquid impermeable sleeve 340a but only to a position below the upper end 342a of the liquid impermeable sleeve 340a, preferably to a position in an upper portion 352a of the liquid impermeable sleeve 340a. Shown in FIG. 28 is a cross-section through the sleeve 340a which reveals the pleated nature of the expansion elements 362a therein. When an upper portion 352a of the liquid impermeable sleeve 340a is removed (as described in detail above in relation to the upper portion 352 of the liquid impermeable sleeve 340), the expansion elements 362a can expand as for the liquid impermeable sleeve 340 as described above, thereby causing portions of a skirt portion 360a to extend angularly from the base portion 358a as described in detail herein above with reference to the skirt portion 360a of the decorative cover 366 depicted in FIG. 26.

While the expansion elements illustrated and described herein are provided with a pleated configuration, U.S. Pat. No. 5,615,535, issued to Weder on Apr. 1, 1997, the Specification of which is hereby expressly incorporated herein by reference, discloses other configurations for expansion elements, such as Z-shaped expansion elements and fluted or groove-shaped expansion elements. U.S. Pat. No. 5,615,535 also discloses the use of a plurality of detachable notches in combination with sleeves constructed in a similar manner to the sleeves of the present invention. In addition, U.S. Pat. No. 6,125,578, issued to Weder on Oct. 3, 2000; U.S. Pat. No. 6,182,395, issued to Weder et al on Feb. 6, 2001; U.S. Pat. No. 6,185,903, issued to Weder et al on Feb. 13, 2001; and U.S. Pat. No. 6,185,904, issued to Weder et al on Feb. 13, 2001, the Specifications of which are all expressly incorporated herein by reference, also disclose sleeves with conformations similar to those disclosed herein which are provided with other configurations of expansion elements. Therefore, the present invention is not limited to the configurations of expansion elements shown in FIGS. 25-28, but also include any configuration disclosed in the above-referenced patents or any configuration known to those of ordinary skill in the art.

Each of the sleeves described herein may further comprise an extended portion which extends away from a portion of an upper end of the sleeve and which serves as a handle or support extension. Shown in FIG. 29 is a liquid impermeable sleeve 340b similar to the liquid impermeable sleeve 340a, except that the liquid impermeable sleeve 340b is provided with a support extension 368 which extends away from an upper end 342b of the liquid impermeable sleeve 340b. The support extension 368 is provided with one or more apertures 370 disposed therein for allowing the liquid impermeable sleeve 340b to be supported on a support assembly 372, which may comprise, for example, a pair of wickets 374 for shipment, storage, assembly of the liquid impermeable sleeve 340b, placement of a flower pot within the liquid impermeable sleeve 340b, or other functions known in the art. The support extension 368 may have a detaching element 376, such as a plurality of perforations as shown in FIG. 29 or any other embodiment of a detaching element as described in detail herein above, for allowing the support extension 368 to be removed from the liquid impermeable sleeve 340b after the liquid impermeable sleeve 340b has been provided for use as described elsewhere herein. In another version of the invention and applicable to any of the sleeves described herein above, shown in FIG. 30 is a liquid impermeable sleeve 340c similar to the liquid impermeable sleeves 340a and 340b, except that the liquid impermeable sleeve 340c is provided with at least one handle 378 extending from an upper end 342c thereof for carrying a potted plant package, formed of the liquid impermeable sleeve 340c and the potted plant 60 (not shown), by the sleeve 340c. The liquid impermeable sleeve 340c further comprises a detaching element 380, such as a plurality of perforations as shown in FIG. 30 or any other embodiment of a detaching element as described in detail herein above, for removing the handle 378 at a later time.

Each of the liquid impermeable sleeves 340-340c shown in FIGS. 25-30 and described herein are provided with liquid impermeable seals in the lower ends 344-344c, respectively, thereof, and/or in the sidewalls 345-345c, respectively, thereof, as described herein before in detail with respect to the liquid impermeable sleeves 10-10e, 80, 130 and 180. The seals of the liquid impermeable sleeves 340-340c, as well as the methods for forming such seals in the liquid impermeable sleeves 340-340c, will be understood to be formed from any of the materials and methods described herein and will include all of the characteristics described in detail with regards to the seals of the other liquid impermeable sleeves 10-10e described herein, such as the seals 32-32e, 34-34e and 36-36e.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined herein.

1. A method of wrapping a potted plant and comprising the steps of:
providing a potted plant comprising a flower pot and a floral grouping disposed in the flower pot, the flower pot having an upper end, a lower end and an outer peripheral surface;
providing a flexible sleeve which is substantially liquid impermeable, the flexible sleeve having an outer surface, an inner surface, an upper end, a lower end, a sidewall and an inner retaining space into which the flower pot is disposable and which is accessible through the upper end, the flexible sleeve further comprising a lower portion and an upper portion wherein the upper portion is detachable from the lower portion, at least a portion of the flexible sleeve constructed from a material which is substantially liquid impermeable and comprising at least one layer of polymeric film, the flexible sleeve having seals in at least one of the sidewall and lower end thereof which are substantially liquid impermeable;
opening the flexible sleeve and placing the potted plant within the inner retaining space of the flexible sleeve wherein the lower portion of the flexible sleeve surrounds at least a portion of the outer peripheral surface of the flower pot, and wherein the upper portion of the flexible sleeve encompasses at least a portion of the floral grouping disposed within the flower pot; and
wherein the upper portion of the flexible sleeve is detachable from the lower portion of the flexible sleeve, thereby forming a decorative plant cover.

2. The method of claim 1 wherein, in the step of providing the flexible sleeve, the material from which at least a portion of the flexible sleeve is constructed comprises a layer of polymeric film having at least one surface thereof laminated with another layer of polymeric film.

3. The method of claim 2 wherein only the lower portion of the flexible sleeve is constructed of a material comprising a layer of polymeric film having at least one surface thereof laminated with another layer of polymeric film.

4. The method of claim 2 wherein the upper and lower portions of the flexible sleeve are constructed of the same material.

5. The method of claim 1 wherein, in the step of providing the flexible sleeve, the material from which at least a portion of the flexible sleeve is constructed comprises a layer of polymeric film having at least one surface thereof extrusion coated with another layer of polymeric film.

6. The method of claim 5 wherein only the lower portion of the flexible sleeve is constructed of a material comprising a layer of polymeric film having at least one surface thereof extrusion coated with another layer of polymeric film.

7. The method of claim 5 wherein the upper and lower portions of the flexible sleeve are constructed of the same material.

8. The method of claim 1 wherein, in the step of providing the flexible sleeve, the material from which at least a portion of the flexible sleeve is constructed comprises a layer of polymeric film and a second material disposed on at least a portion of one surface thereof such that upon forming the seals in at least one of the sidewall and lower end of the flexible sleeve, the second material fills any voids which may form in the layer of polymeric film, thereby forming seals which are substantially liquid impermeable, wherein the second material is selected from the group consisting of heat sealable lacquer, low temperature melting material, cold sealing material, bonding material, pressure sensitive adhesive and combinations thereof.

9. The method of claim 1 wherein, in the step of providing the flexible sleeve, the seals in at least one of the sidewall and lower end are selected from the group of seals consisting of weld seals, lap seals, fin seals, butt seals, zippers and combinations thereof.

10. The method of claim 1 wherein, in the step of providing the flexible sleeve, at least one of the lower end and the sidewall is provided with at least one gusset therein.

11. The method of claim 1 wherein, in the step of opening the flexible sleeve and disposing the potted plant therein, no overlapping folds are formed in the lower portion of the flexible sleeve.

12. The method of claim 1 wherein, in the step of providing the flexible sleeve, the lower portion of the flexible sleeve comprises a base portion and a skirt portion, and the skirt portion is provided with a decorative upper edge upon detachment of the upper portion of the flexible sleeve from the lower portion of the flexible sleeve.

13. The method of claim 1 wherein, in the step of providing the flexible sleeve, the flexible sleeve is further provided with an extended portion extending from the upper end thereof for serving as a handle or support extension.

14. The method of claim 1 wherein, in the step of providing the flexible sleeve, the flexible sleeve is further provided with at least one expansion element which is integral to at least one of the base portion and the skirt portion of the flexible sleeve and allows for expansion of a portion of the skirt portion of the flexible sleeve.

15. A substantially liquid impermeable package for a potted plant, the potted plant comprising a flower pot having an upper end and an outer peripheral surface and a floral grouping disposed in the flower pot, the substantially liquid impermeable package comprising:
a flexible sleeve which is substantially liquid impermeable, the flexible sleeve having an outer surface, an inner surface, an upper end, a lower end, a sidewall and an inner retaining space into which the flower pot is disposable and which is accessible through the upper end, at least a portion of the flexible sleeve constructed from a material which is substantially liquid impermeable and comprising at least one layer of polymeric film and the flexible sleeve having seals formed in at least one of the sidewall and lower end thereof which are substantially liquid impermeable, the flexible sleeve further comprising:
a lower portion sized to surround and encompass at least a portion of the outer peripheral surface of the flower pot when the potted plant is disposed in the flexible sleeve;
an upper portion being sized to encompass at least a portion of the floral grouping disposed within the flower pot when the potted plant is disposed in the flexible sleeve; and
wherein the upper portion is detachable from the lower portion, thereby forming a decorative plant cover which is substantially liquid impermeable.

16. The substantially liquid impermeable package for a potted plant of claim 15 wherein the material from which at least a portion of the flexible sleeve is constructed comprises a layer of polymeric film having at least one surface thereof laminated with another layer of polymeric film.

17. The substantially liquid impermeable package for a potted plant of claim 16 wherein only the lower portion of the flexible sleeve is constructed of a material comprising a layer of polymeric film having at least one surface thereof laminated with another layer of polymeric film.

18. The substantially liquid impermeable package for a potted plant of claim 16 wherein the upper and lower portions of the flexible sleeve are constructed of the same material.

19. The substantially liquid impermeable package for a potted plant of claim 15 wherein the material from which at least a portion of the flexible sleeve is constructed comprises a layer of polymeric film having at least one surface thereof extrusion coated with another layer of polymeric film.

20. The substantially liquid impermeable package for a potted plant of claim 19 wherein only the lower portion of the flexible sleeve is constructed of a material comprising a layer of polymeric film having at least one surface thereof extrusion coated with another layer of polymeric film.

21. The substantially liquid impermeable package for a potted plant of claim 19 wherein the upper and lower portions of the flexible sleeve are constructed of the same material.

22. The substantially liquid impermeable package for a potted plant of claim 15 wherein the material from which at least a portion of the flexible sleeve is constructed comprises a layer of polymeric film and a second material disposed on at least a portion of one surface thereof such that upon forming the seals in at least one of the sidewall and lower end of the flexible sleeve, the second material fills any voids which may form in the layer of polymeric film, thereby forming seals which are substantially liquid impermeable, wherein the second material is selected from the group consisting of heat sealable lacquer, low temperature melting material, cold sealing material, bonding material, pressure sensitive adhesive and combinations thereof.

23. The substantially liquid impermeable package for a potted plant of claim 15 wherein the seals in at least one of the sidewall and lower end of the flexible sleeve are selected from the group of seals consisting of weld seals, lap seals, fin seals, butt seals, zippers and combinations thereof.

24. The substantially liquid impermeable package for a potted plant of claim 15 wherein at least one of the lower end and the sidewall of the flexible sleeve is provided with at least one gusset therein.

25. The substantially liquid impermeable package for a potted plant of claim 15 wherein no overlapping folds are formed in the lower portion of the flexible sleeve.

26. The substantially liquid impermeable package for a potted plant of claim 15 wherein the lower portion of the flexible sleeve comprises a base portion and a skirt portion, and the skirt portion is provided with a decorative upper edge upon detachment of the upper portion of the flexible sleeve from the lower portion of the flexible sleeve.

27. The substantially liquid impermeable package for a potted plant of claim 26 wherein the flexible sleeve is further provided with at least one expansion element which is integral to at least one of the base portion and the skirt portion of the flexible sleeve and allows for expansion of a portion of the skirt portion of the flexible sleeve.

28. The substantially liquid impermeable package for a floral grouping of claim 15 wherein the flexible sleeve is further provided with an extended portion extending from the upper end thereof for serving as a handle or support extension.

29. The method of claim 1 wherein, in the step of providing a flexible sleeve, the lower end of the flexible sleeve is closed.

30. The method of claim 1 wherein, in the step of providing a flexible sleeve, the lower portion of the flexible sleeve has an upper end, and the flexible sleeve is tapered from the lower end of the flexible sleeve toward a larger diameter at the upper end of the lower portion.

31. The method of claim 1 wherein, in the step of providing a flexible sleeve, the upper portion of the flexible sleeve is detachable from the lower portion via a line of perforations.

32. The substantially liquid impermeable package for a floral grouping of claim 15 wherein the lower end of the flexible sleeve is closed.

33. The substantially liquid impermeable package for a floral grouping of claim 15 wherein the lower portion of the flexible sleeve has an upper end, and the flexible sleeve is tapered from the lower end of the flexible sleeve toward a larger diameter at the upper end of the lower portion.

34. The substantially liquid impermeable package for a floral grouping of claim 15 wherein the upper portion of the flexible sleeve is detachable from the lower portion via a line of perforations.

35. A method of wrapping a potted plant and comprising the steps of:
providing a potted plant comprising a flower pot and a floral grouping disposed in the flower pot, the flower pot having an upper end, a lower end and an outer peripheral surface;
providing a flexible sleeve which is substantially liquid impermeable, the flexible sleeve having an outer surface, an inner surface, an upper end, a lower end, a sidewall and an inner retaining space into which the flower pot is disposable and which is accessible through the upper end, at least a portion of the flexible sleeve constructed from a material which is substantially liquid impermeable and comprising at least one layer of polymeric film, the flexible sleeve having seals in at least one of the sidewall and lower end thereof which are substantially liquid impermeable; and
opening the flexible sleeve and placing the potted plant within the inner retaining space of the flexible sleeve wherein the flexible sleeve surrounds at least a portion of the outer peripheral surface of the flower pot, thereby forming a decorative plant cover.

36. The method of claim 35 wherein, in the step of providing the flexible sleeve, the material from which at least a portion of the flexible sleeve is constructed comprises a layer of polymeric film having at least one surface thereof laminated with another layer of polymeric film.

37. The method of claim 35 wherein, in the step of providing the flexible sleeve, the material from which at least a portion of the flexible sleeve is constructed comprises a layer of polymeric film having at least one surface thereof extrusion coated with another layer of polymeric film.

38. The method of claim 35 wherein, in the step of providing the flexible sleeve, the material from which at least a portion of the flexible sleeve is constructed comprises a layer of polymeric film and a second material disposed on at least a portion of one surface thereof such that upon forming the seals in at least one of the sidewall and lower end of the flexible sleeve, the second material fills any voids which may form in the layer of polymeric film, thereby forming seals which are substantially liquid impermeable, wherein the second material is selected from the group consisting of heat sealable lacquer, low temperature melting material, cold sealing material, bonding material, pressure sensitive adhesive and combinations thereof.

39. The method of claim 35 wherein, in the step of providing the flexible sleeve, the seals of at least one of the sidewall and lower end are selected from the group of seals consisting of weld seals, lap seals, fin seals, butt seals, zippers and combinations thereof.

40. The method of claim 35 wherein, in the step of providing the flexible sleeve, at least one of the lower end and the sidewall is provided with at least one gusset therein.

41. The method of claim 35 wherein, in the step of providing a flexible sleeve, the lower end of the flexible sleeve is closed.

42. A substantially liquid impermeable package for a potted plant, the potted plant comprising a flower pot having an upper end and an outer peripheral surface and a floral grouping disposed in the flower pot, the substantially liquid impermeable package comprising:
a flexible sleeve which is substantially liquid impermeable, the flexible sleeve having an outer surface, an inner surface, an upper end, a lower end, a sidewall and an inner retaining space into which the flower pot is disposable and which is accessible through the upper end, at least a portion of the flexible sleeve constructed from a material which is substantially liquid impermeable and comprising at least one layer of polymeric film and the flexible sleeve having seals formed in at least one of the sidewall and lower end thereof which are substantially liquid impermeable.

43. The substantially liquid impermeable package for a potted plant of claim 42 wherein the material from which at least a portion of the flexible sleeve is constructed comprises a layer of polymeric film having at least one surface thereof laminated with another layer of polymeric film.

44. The substantially liquid impermeable package for a potted plant of claim 42 wherein the material from which at least a portion of the flexible sleeve is constructed comprises a layer of polymeric film having at least one surface thereof extrusion coated with another layer of polymeric film.

45. The substantially liquid impermeable package for a potted plant of claim 42 wherein the material from which at least a portion of the flexible sleeve is constructed comprises a layer of polymeric film and a second material disposed on at least a portion of one surface thereof such that upon forming the seals in at least one of the sidewall and lower end of the flexible sleeve, the second material fills any voids which may form in the layer of polymeric film, thereby forming seals which are substantially liquid impermeable, wherein the second material is selected from the group consisting of heat sealable lacquer, low temperature melting material, cold sealing material, bonding material, pressure sensitive adhesive and combinations thereof.

46. The substantially liquid impermeable package for a potted plant of claim 42 wherein the seals of at least one of the sidewall and lower end of the flexible sleeve are selected from the group of seals consisting of weld seals, lap seals, fin seals, butt seals, zippers and combinations thereof.

47. The substantially liquid impermeable package for a potted plant of claim 42 wherein at least one of the lower end and the sidewall of the flexible sleeve is provided with at least one gusset therein.

48. The substantially liquid impermeable package for a floral grouping of claim 42 wherein the flexible sleeve is further provided with an extended portion extending from the upper end thereof for serving as a handle or support extension.

49. The substantially liquid impermeable package for a floral grouping of claim 42 wherein the upper portion of the flexible sleeve is detachable from the lower portion via a line of perforations.

50. A substantially liquid impermeable package for a potted plant, the potted plant comprising a flower pot having an upper end and an outer peripheral surface and a floral grouping disposed in the flower pot, the substantially liquid impermeable package comprising:
a flexible sleeve which is substantially liquid impermeable, the flexible sleeve having an outer surface, an inner surface, an upper end, a lower end, a sidewall and an inner retaining space into which the flower pot is disposable and which is accessible through the upper end, at least a portion of the flexible sleeve constructed from a material which is substantially liquid impermeable and comprising at least one layer of polymeric film and the flexible sleeve having seals formed in at least one of the sidewall and lower end thereof which are substantially liquid impermeable, and wherein the flexible sleeve comprises a feature selected from the group consisting of:
(a) an upper portion and a lower portion wherein the upper portion is detachable from the lower portion;
(b) an upper portion and a lower portion wherein the upper portion is detachable from the lower portion via a line of perforations;
(c) the flexible sleeve being tapered from the lower end thereof toward a larger diameter at the upper end thereof;
(d) an upper portion and a lower portion having an upper end, wherein the flexible sleeve is tapered from the lower end thereof toward a larger diameter at the upper end of the lower portion;
(e) wherein the lower end of the flexible sleeve is closed; and
(f) combinations thereof.

51. A method of wrapping a potted plant and comprising the steps of:
providing a potted plant comprising a flower pot and a floral grouping disposed in the flower pot, the flower pot having an upper end, a lower end and an outer peripheral surface;
providing a flexible sleeve which is substantially liquid impermeable, the flexible sleeve having an outer surface, an inner surface, an upper end, a lower end, a sidewall and an inner retaining space into which the flower pot is disposable and which is accessible through the upper end, at least a portion of the flexible sleeve constructed from a material which is substantially liquid impermeable and comprising at least one layer of polymeric film, the flexible sleeve having seals in at least one of the sidewall and lower end thereof which are substantially liquid impermeable, and wherein the flexible sleeve comprises a feature selected from the group consisting of:
(a) an upper portion and a lower portion wherein the upper portion is detachable from the lower portion;
(b) an upper portion and a lower portion wherein the upper portion is detachable from the lower portion via a line of perforations;
(c) the flexible sleeve being tapered from the lower end thereof toward a larger diameter at the upper end thereof;
(d) an upper portion and a lower portion having an upper end, wherein the flexible sleeve is tapered from the lower end thereof toward a larger diameter at the upper end of the lower portion;
(e) wherein the lower end of the flexible sleeve is closed; and
(f) combinations thereof; and
opening the flexible sleeve and placing the potted plant within the inner retaining space of the flexible sleeve wherein the flexible sleeve surrounds at least a portion of the outer peripheral surface of the flower pot, thereby forming a decorative plant cover.
